(19) United States
(12) Patent Application Publication
(10) Pub. No.: US 2010/0293084 A1
(43) Pub. Date: Nov. 18, 2010

(54) System and method for creating and supplying particular data constructs, and methods for using such data constructs in evaluating whether to buy or sell a traded security

(75) Inventor: Donald Soubolsky, Calgary (CA)

Correspondence Address: GOWLING LAFLEUR HENDERSON LLP, SUITE 1400, 700 2ND ST. SW, CALGARY, AB, T2P 4V5, CA

(73) Assignee: Oculus Equities Inc., Calgary (CA)

(21) Appl. No.: 12/453,505

(22) Filed: May 13, 2009

(51) Int. Cl. G06Q 40/00

(52) U.S. Cl. 705/37; 705/35

(57) ABSTRACT

A system and method for transforming raw trading data for a traded security so as to create new financial data constructs, which constructs can further be used in traditional methods and using other methods disclosed herein to better evaluate whether to buy or sell a traded security. Various trading methods, using the new data constructs, are further disclosed. New financial data constructs, including particularly Real Buying Pressure (RBP) and Real Selling Pressure (RSP), are further disclosed.

### FIELD OF THE INVENTION

The present invention broadly relates to a system and method for transforming traditionally-available ‘raw’ market data (raw-market data) in traded securities into particular data constructs which provide further insight into the likely future performance of a traded security, and permit utilization of certain methods which assist in evaluating whether to buy or sell a traded security. The invention further relates to providing such generated data constructs to the public for a fee.

This newly created data looks “inside-the-trade” and records where the trade takes place, in relation to the spread. This newly created data called Oculus Second Level Data is contrasted to traditional market data which only summarizes opening price, highest price, lowest price, closing price and traded volume for any given time period.

### BACKGROUND OF THE INVENTION AND DESCRIPTION OF THE PRIOR ART

Traditional market data in respect of publicly traded securities is provided electronically to the public via web servers in real time. This traditional market data, which may be provided via a “live feed”, for which interested parties may purchase for a monthly or annual fee from a data provider, typically consists of the following data for each security listed on a stock exchange for a given time period:

Open price—is the first traded price for any given time period;

High price—is the highest traded price for any given time period;

Low price—is the lowest traded price for any given time period;

Close price—is the last traded price for any given time period;

Volume—is the total volume of all trades for any given time period;

For example, one such electronic source of such above traditional data in traded securities is presently available from wwQuote.com, a tradename of DTN Market Access LLC Ltd. of Delaware, of Omaha, Nebr. Over the past 50 years, investment analysts have developed a group of indicators based on the trade market data of investments. For example, moving averages (MA), relative strength indexes (RSI), K/D stochastic analysis, moving average convergence divergence (MACD), Bollinger Bands, and various indexes are among the most popular indicators the general public uses to describe individual investments as well as the market as a whole.

For the purpose of analyzing investments and designing trading strategies, traders and investment analysts plot investment prices, volumes and other indicators on investment charts. These charts are often used to assist in analyzing the security, and to determine when best to buy and when to sell.

Many investment analysts and traders design trading strategies and make decisions based on technical analysis. They believe that publicly available technical data of an investment such as historical open, high, low, close prices, daily volumes, the last trade price and the size contain a certain amount of information that can be used to predict the future movements of the investment and that, therefore, analyzing this data can help make them profits.

Traders may also use software tools to chart and graphically display market information or data calculated using the market information. Over the years, a number of these software tools, in the form of analysis systems and graphical charting displays, have been created to assist traders in analyzing and attempting to predict market behavior. By providing such information, traders are generally able to assimilate enormous amounts of data and make more informed decisions. The use of such tools has also enhanced the level of intuition a trader may gain when trading in an electronic trading environment.

A conventional method of assimilating market information received from an exchange is to chart the information on a graph. Traders use many different methods of charting market information, such as historical or real time market data charts, pie charts, bar charts, or traditional candlestick charts. Similarly, many different types of market information can be charted. For example, moving average of closing price vs. closing price. Traders often use the charted market information to assist them in identifying market patterns and market trends.

As mentioned, investment analysts have designed trading strategies using proven market indicators such as Moving Average, Relative Strength Index and MACD using traditional data such as the closing price of the security.

The amount of available market information and the computing capability of this data in recent years has led to the development of quantitative investment funds that use computers to analyze the data and make all trading decisions, including buying, selling and the actual trade execution. The investment funds that specialize in this type of trading are called quant funds and can trade around the clock and around the world.

US Publication 2008/0249960_(TAB 1) relates generally to an automated system and method for automatically buying and selling equity securities on market trends in response to pre-established decision models, and accordingly is not specifically directed to methods or manners of creating a new type of variable to analyze whether to buy or sell. Specifically, although the patent application teaches basing a buy or sell decision on data compiled from price, volume, bids, asks, spread, number of shares a each price level of bid etc, (eg para. 56), and further discloses that a “component” (para. 57) namely the feature which determines whether to “buy” or “sell” may be how close the current price is to the inside bid or ask, there is no disclosure of any trending analysis of such data, nor of any trending data created as a result of applied algorithms.

US Publication 2007/0239585 teaches a rather simplistic method for determining whether to buy or sell shares, based on “buying pressure”, which may be simply a ratio based on the number of shares sought and the number of shares offered, (para. 98), which may be calculated over differing time intervals. It further discloses that offers for sale, or requests for purchase for which the proposed transaction differs from a predetermined amount may be discarded from the calculation of buying pressure (see para. 95). The calculated value serves as the “trigger” when exceeding a certain amount to initiate a “buy”. The actual “buyer pressure” may be (i) absolute buyer pressure indicator values, relative buyer pressure, differences between buyer pressure ratios, the rate of change of the buyer pressure indicator over a period of time, absolute price thresholds, or recent changes in share prices. (see para. 103-109). Notably, however, this patent application does not disclose certain features of the present invention, namely the creation of RBP and RSP data constructs and the application of known trending methods to those new “third level” created data constructs—rather the method of this publication is less sophisticated and simply discloses the calculation of an instantaneous buying pressure as a trigger to buy shares in that stock.

US Publication 2006/0265320 discloses a means of charting “depth of market” activity of a stock or group of stocks, namely whether current trades originated as buy orders (an upwardly facing triangle—see FIG. 7), or as sell orders (ie the bid price was met, namely a downwardly-facing triangle—see FIG. 7). Two key figures of the publication are FIGS. 7 and 8. Echoic options may be added to trigger audible alarms when certain trading figures/values/volumes etc are reached. Notably, however, this patent makes no disclosure of a means of calculating RBP or RSP, and plotting same via RSI or stochastic oscillator curves, to then determine points to buy or sell.

US Publication (2005/0187854) broadly discloses a method and system to monitor securities market activity, and in a particular embodiment, level 1 and/or level 2 data (asking price, bid price) are analyzed. One formula is disclosed for determining a “rank value”, namely:

$$Rank value = \frac{Last Trade Value - session low}{{Day}^{′} s Range}$$

US Publication 2005/0075965 is a published application by the same inventor as US publication '854 above. It discloses similar subject matter to US '854 above. As seen from Figures such as 4A and 4B, such uses the variables of Buy and Sell Pressure, and does further monitor “bid” and “ask” values. In addition, a method of charting (FIG. 5A, and para. 160-163 is disclosed). Such method, however, does not appear for the purpose of applying stochastic analysis, but rather appears more concerned with “zooming in” on a particular time point of interest (eg item 156 in FIG. 5A, and para. 163).

U.S. Pat. No. 6,272,474 teaches an early (1999) modification to prior art “candlestick” trading screens to depict further relevant information. Specifically, in a first embodiment (shown in FIG. 3 thereof) a prior art trading screen is modified by adding bid/ask trade bars, which comprise three sections, wherein the top section of the volume bar is color coded red to indicate percentage of sales that occurred at the bid prices or lower. Other color coded bars give similar additional information. In a second embodiment (shown in FIG. 4 thereof)(eg bottom col. 7), provides a horizontal bid/ask trade bar at the bottom of the screen, likewise having colour-coded sections, with percentages trading at the bid, ask, or between bid and ask prices.

U.S. Pat. No. 6,912,511 is broadly directed to a method of stock trending analysis based on calculating a bid-offer spread from initial market data and second (later obtained) market data, which is used to calculate (give an indication of) an average deal rate or deal density, and from such data thereafter determining market liquidity in accordance with an applied scaling law. (eg ref. claim 1 thereof).

US Publication 2007/0067233 entitled “Financial Decision Systems” appears to disclose, in the various 63 Figures, a means of using charting means, with indications of buying pressure and selling pressure, and points of “crossing” of such charted lines, to indicate buying or selling points. Specifically, the basis of the algorithm is set out in para. 's 98 and 99, where V1 (one of the two plotted data) comprises selling pressure over a particular timeframe (one minute to one year) against a similarly plotted line of buying pressure (V2) These, as indicated in para. 100, may be created using “mathematical formulas”, although the specifics of the formulas do not appear disclosed.

U.S. Pat. No. 7,212,999 entitled “User Interface for an electronic trading system” broadly relates to a system which allows individual traders to place orders on remote client terminals, which is routed to a transaction server which matches a bid for an item to an offer for an item. Disclosure is further made of terminals which display al of the outstanding bids and offers for an “item” (eg traded security), where orders are displayed as tokens at locations corresponding to the values of the order, and the size of the token reflects the quantity of the order. The rather primitive trending in this patent is accomplished by for example, bid icons and offer icons being graphed for all outstanding bids and offers being displayed on the graph at locations corresponding to the values of the bids and offers. The trader may immediately then see the increasing demand for an item as it occurs, and can enter an order to buy. The same appears to apply to selling.

US Publication 2005/0080710 to a “Method and Apparatus for Providing Trading Information” again appears to be a patent application relating to the type of usual trading information presented graphically, rather than a more sophisticated means of data creation to create new trending data which itself can be graphically plotted, to analyze points of intersection and inflection to give information what is believed to be more significant trending analysis. Such does, for example in para. 14, teach a method of generating price “deltas” comprising ask trade volumes less bid trade volumes, but no further analysis of determining buying pressure or selling pressure is disclosed in this application.

US Publication 2002/0026404 is a somewhat early application which broadly discloses an apparatus and method for providing a visual display to a two line cross-over method, signaling buying and selling opportunities (see para. 002 and FIG. 5). The two lines in FIG. 5 (see para. 45) are two multiple linear regression chars lines, line 540 to indicate opening prices and the other color coded to indicate closing prices. While other means of market trend indicators are broadly disclosed [eg stochastics, RSI (relative strength), etc, see para. 49] this application makes no specific detail as to how they would be employed, and importantly makes no disclosure of using stochastics of RBP or RSP.

US Publication 2006/0293997 is to the same inventor as issued U.S. Pat. No. 7,403,921 and contains in part similar disclosure. Such publication teaches a method of calculating and displaying traded volume (Cumulative Volume Delta) to determine the aggressiveness towards either the bid or ask side of the market, purportedly more intelligently than the On Balance Volume (‘OBV’) method in the prior art, which adds or subtracts each traded volume to or from the running total volume based on relative price movement between the current trade and the last trade. As disclosed in this patent application relating to the CVD method (Cumulative Volume Delta), such involves determining a traded volume analysis by adding or subtracting the volume associated with each trade from the running total volume, wherein the decision to add or subtract the volume from the running total volume is based on what side of the market each trade was initiated on. As disclosed in para. 0064-0081 various charting methods may be employed, to arrive at appropriate buy and sell points, such as plotting CVD versus trading prices (FIG. 6) FIG. 8 shows CVD calculated across sectors.

U.S. Pat. No. 5,297,032 to a “Securities Trading Workstation” is a very early patent (1994), which discloses a workstation which is programmed to receive the feed of data from a database and convert into a form conducive to enhanced trading. Seven separate applications permit the trader to track the market, select securities, bid and ask pricing. Such data may be arranged by best Bid or Best Ask Price (col 3, lines 15-20). Significantly, there appears to be no particular means of calculating additional performance monitoring parameters (eg RSP or RBP), or of stochastic means of analyzing such data to permit determination of appropriate buy points or sell points.

U.S. Pat. No. 7,403,921 relates to a system and method for calculating and displaying volume of a traded security to identify aggressive buying or selling activity in a traded security. Market information comprising last trade price, last traded quantity, a highest bid price and a lowest ask price is received from the electronic trading exchanges. Significantly differently than in the present invention, a current “running total volume” is determined by adding or subtracting the last traded quantity from a preceding running total volume, based on the determination of whether the last trade occurred on the bid side or on the ask side in respect of a traded security. The running total volume is then used to assist a trader in determining in which direction the traded security is likely to move.

With the exception of U.S. Pat. No. 7,403,921, a fundamental limitation of traditional data and methods is that nothing is known about where the trade took place—whether it took place above, below, or equal to the BID price or the ASK price. Thus significant information regarding securities trading as to where in relation to the bid price or the ask price of a traded security is thus overlooked, which could otherwise be captured and used to better predict likely increases or decreases to prices of traded securities.

As to U.S. Pat. No. 7,403,921, the maintaining of a “running tally” of traded volumes is but a crude method of obtaining an idea of whether the price of a traded security is likely to increase or decrease. Moreover, the single created data construct of a “running tally” is only a second-level generated data—no means is disclosed in such patent for creating further data constructs from such generated “running tally” to thereby achieve a “third level” of refinement from the first level of supplied “raw” data.

Accordingly, a real need exists for data constructs created from “raw” electronically available data, where such data constructs not only provide useful information as to whether each trade took place above, below, or equal to the BID price or the ASK price (and thus an insight into which direction the stock may be headed), but further may themselves be used to generate a third level of data constructs, which adds yet a further layer of additional information which may then be used in the various methods further disclosed herein to predict likely future performance of such security.

### SUMMARY OF THE INVENTION

In order to overcome the shortcomings of the methods of the prior art, the method of the present invention creates four (4) data constructs, namely:

DNV (“Downward Volume”);

UPV (“Upward Volume”);

NBP (“Net Buying Pressure”), and

NSP (“Net Selling Pressure”)

in accordance with various formulae from “raw-market data”, thereby transforming such raw data into new data constructs which provide more useful information than traditional market data that summarizes the trading activity. (Examples of traditional market data are opening price, highest price, lowest price, closing price and traded volume.) Such data constructs (hereinafter referred to as “Second Level Oculus Data”) not only incorporate a reflection as to whether a trade took place above, below, or equal to the ask price and may be used as an predictor of future prices of a traded security, but further such data constructs may themselves together be used in real time to create additional higher level data constructs, namely “third” level data constructs, namely:

RBP (“Real Buying Pressure”); and

RSP (“Real Selling Pressure”)

Such “third level” data constructs may then be used in additional disclosed methods to determine in real time when it is likely best to purchase a security, and when it is likely a good time to sell a traded security.

By way of general background to the advantages of the above data constructs, it is necessary to understand the significance of knowledge in respect of where a recent trade in a security took place in respect of the recent bid price and ask price in respect of such traded security.

In this regard, financial securities are bought and sold just like houses. There exists a bid price and the asking price. A house that is sold at a price close to or at the asking price would be considered bought and would add buying pressure in the market place. A house that is sold at the bid price would be considered sold putting downward pressure or selling pressure in the market place. In hot real estate markets when prices are going up there is a lot of buying pressure in the market. Several bidders can appear and the house can be sold at or above the asking price. This is condition happens when there is a lot of buying pressure in the market place. The market for houses eventually cools down to a point where the selling price is closer to the bid price. If the selling price of a house is examined and compared to the asking price, a forthcoming weakness in the housing market can be detected well before the actual housing prices decline.

Like the housing market, in one broad aspect of the invention in which a method is used to generate a number of data constructs, such method typically identifies where each trade takes place, and makes use of a comparison of the LAST price to the SPREAD which is the difference between the best BID price and the best ASK price.

In the most simple terms; if the transaction price, or LAST price, of the security is equal to the BID price, it is considered sold, and if the transaction price of the security is equal to the ASK price, it is considered bought. If a security is bought, there is more buying pressure than selling pressure calculated and vise versa when a security is sold.

Raw-market data is received from a multiplicity of exchanges in real-time. This series of data consists of the following:
BID prices—the value that buyers are willing to pay for a particular security;
Volume associated with the BID prices—shows the quantity of the security at the BID prices;
Best BID price—is the highest value of all BID prices;
Volume associated with the best BID price—shows the quantity of the security at the best BID price;
ASK prices—the value that sellers are willing to sell for a particular security;
Volume associated with the ASK prices—shows the quantity of the security at the ASK prices;
Best ASK price—is the lowest value of all ASK prices;
Volume associated with the best ASK price—shows the quantity of the security at the best ASK price;
LAST price—shows the price of security last traded; and
VOLUME—shows the volume traded at the LAST price.

Raw-market data is processed, as more fully described herein, using a series of applied rules, to calculate “Second Level Oculus Data”, namely the data constructs DNV, UPV, NBP, and NSP, in real time. Like traditional market data, Second Level Oculus Data is stored in one-minute time intervals.

A user, such as a securities trader, accesses Second Level Oculus Data (which may be bought and sold like traditional market data, using a web-based application, and provision may be made to permit such trader to display and chart all Second Level Oculus Data, as well as Third Level Oculus data. Traditional market data can also be displayed and compared to Second and/or Third Level Oculus Data.

Such web-based information can be accessed with any device that has a wireless or land based Internet connection. The application devices include, but are not limited to computers, web-based telephones, PDA's or any other internet-accessing devices.

A traded security is hereby defined and intended as including any tradable object that can be traded with a quantity and/or price. It includes but is not limited to all types of traded events, goods, and/or financial products, which can include, for example, stocks, Electronic Traded Funds (ETF) options, bonds, futures, currency, and warrants, as well as funds, derivatives and collections of the foregoing, and all types of commodities, such as grains, energy, or metals. The tradable object may be “real,” such as products that are enlisted by and exchange for trading, or “synthetic”, such as a combination of real products that are created by the user. A tradable object can actually be a combination of other tradable objects, such as a class of tradable objects.

The Necessary Component of the Methodology for Creating Second Level Oculus Data

In the broadest aspect of the present invention, the invention comprises a method of transforming raw-market data for a traded security so as to create new financial data constructs UPV, DNV, NBP, and NSP in respect of trades in a traded security. These data constructs effectively provide additional information in respect of a traded security or group of traded securities, such as a bond fund, a mutual fund, a group of publicly-traded stocks, or even a single stock. The data constructs UPV, DNV, NBP, and NSP shall hereinafter collectively be referred to as “Second Level Oculus Data”. Such Second Level Oculus Data may be used, as hereinafter disclosed, in a number of methods for predicting, in respect of a stock that is held, when it would be advantageous to sell such stock, and in respect of stock which is being considered for purchase, when it would be advantageous to acquire such stock.

Specifically, in such broadest aspect of the present invention, the invention comprises a method of transforming raw-market data for a traded security so as to create new financial data constructs UPV, DNV, NBP, and NSP in respect of trades in a traded security, comprising:

(a) utilizing raw-market data in respect of a plurality of consecutive trades in a traded security, such raw data including, or calculating from such raw data, a highest bid price, a lowest ask price, a traded price and a traded volume in respect of each trade in such traded security; or

(b) utilizing data in respect of a plurality of consecutive trades in a traded security over a defined time interval, such data for each trade including a bid price, an ask price, a last traded price and a traded volume over said defined time interval;

determining, for each trade, if the bid price is less than the ask price (bid<ask), and if so:
(i) determining if the traded price is greater than the bid price and if the traded price is less than the ask price (bid<last<ask), and if so:
   (a) calculating a first data construct (SPREAD) with respect to such trade as being said difference between said ask price and said bid price (SPREAD=ask−bid);
   (b) calculating a second data construct UPV with respect to such trade as the traded price less the bid price divided by the ask price less the bid price multiplied by the traded volume (UPV={[last−bid]/[ask−bid]}×VOL);
   (c) calculating a third data construct (DNV) with respect to such trade as being the traded volume less the UPV (DNV=VOL−UPV);
   (d) calculating a fourth data construct (NSP) with respect to such trade by multiplying DNV×SPREAD;
   (e) calculating a fifth data construct (NBP) with respect to such trade by multiplying UPV×SPREAD;
(ii) determining if the traded price is equal to the ask price and if the traded price is greater than the bid price (last=ask>bid), and if so:
   (a) calculating a first data construct (SPREAD) with respect to such trade as being the difference between said ask price and said bid price (SPREAD=ask−bid);
   (b) calculating a second data construct (UPV) with respect to such trade as the traded price less the bid price divided by the ask price less that the bid price multiplied by the traded volume (UPV={[last−bid]/[ask−bid]}×VOL);
   (c) calculating a third data construct (DNV) with respect to such trade as being the traded volume less the UPV (DNV=VOL−UPV);
   (d) calculating a fourth data construct (NSP) with respect to such trade by multiplying DNV×SPREAD;
   (e) calculating a fifth data construct (NBP) with respect to such trade by multiplying UPV×SPREAD;
(iii) determining if the traded price is equal to the bid price and if the traded price is less than the ask price (last=bid<ask), and if so:
   (a) calculating a first data construct (SPREAD) with respect to such trade as being said difference between said ask price and said bid price (SPREAD=ask−bid);
   (b) calculating a second data construct (UPV) with respect to such trade as the traded price less the bid price divided by the ask price less the bid price multiplied by the traded volume (UPV={[last−bid]/[ask−bid]}×VOL);
   (c) calculating a third data construct (DNV) with respect to such trade as being the traded volume less the UPV (DNV=VOL−UPV);
   (d) calculating a fourth data construct (NSP) with respect to such trade by multiplying DNV×SPREAD;
   (e) calculating a fifth data construct (NBP) with respect to such trade by multiplying UPV×SPREAD;
(iv) determining if the traded price is less than the bid price and if the traded price is less than the ask price (last<bid<ask), and if so:
   (a) calculating a first data construct (SPREAD) with respect to such trade as being said difference between said ask price and said traded price (SPREAD=ask−last);
   (b) setting a second data construct (UPV) with respect to such trade as being equal to zero (UPV=0);
   (c) calculating a third data construct (DNV) with respect to such trade as being the traded volume less the UPV (DNV=VOL−UPV);
   (d) calculating a fourth data construct (NSP) with respect to such trade by multiplying DNV×SPREAD;
   (e) calculating a fifth data construct (NBP) with respect to such trade by multiplying UPV×SPREAD;
(v) determining if the traded price is greater than the ask price and if the traded price is greater than the bid price (last>ask>bid), and if so:
   (a) calculating a first data construct (SPREAD) with respect to such trade as being said difference between said traded price and the bid price (SPREAD=last−bid);
   (b) calculating a second data construct (UPV) with respect to such trade as being equal to the traded volume (UPV=VOL);
   (c) calculating a third data construct (DNV) with respect to such trade as being the traded volume less the UPV (DNV=VOL−UPV);
   (d) calculating a fourth data construct (NSP) with respect to such trade by multiplying DNV×SPREAD;
   (e) calculating a fifth data construct (NBP) with respect to such trade by multiplying UPV×SPREAD.

In a further refinement of the invention, the Second Level Oculus Data, namely the data constructs DNV, UPV, NBP, and NSP, may further be utilized in creating a further level of data constructs, namely RBP (“Real Buying Pressure”), and RSP (“Real Selling Pressure”). These additional data constructs (hereinafter collectively referred to as “Third Level Oculus Data”) provide, and may be used to provide, in the manners hereinafter disclosed, further insights into stock performance, and may likewise be used, in the manner and methods more particularly disclosed below, to better evaluate in respect of a stock that is held when it would be advantageous to sell such stock, and in respect of stock which is being considered for purchase, when it would best be advantageous to acquire such stock.

More particularly, in a further refinement of the method of the present invention, such method comprises the steps of creating further data constructs RBP and RSP comprising the steps of:

summing each of the calculated DNV, UPV, NSP, and NBP as well as the traded volume for each trade which occurred over a defined time interval to create respectively the following data constructs SUMDNV, SUMUPV, SUMNSP, SUMNBP and SUMVOL for said defined time interval; and

calculating said data construct (RSP) for said time interval, as being:

[SUMNSP/(SUMNSP+SUMNBP)]×SUMVOL

and

calculating said data construct (RBP) for said time interval, as being:

[SUMNBP/(SUMNSP+SUMNBP)]×SUMVOL

In the vast majority of security trades, the ask price will typically be greater than the bid price, and thus the above method for creating the Second Level Oculus Data (and thereafter being able to create the Third Level Oculus Data) is all that is usually needed.

However, in unusual and relatively rare market conditions bid price of a traded security may sometimes equal or even surpass the ask price. Stated another way, on some occasions the ask price of a traded security may sometimes (and surprisingly, in times of rapid stock value increase) be temporarily less than the bid price. In such circumstances (where the bid price of a traded security equals the ask price or the bid price exceeds the ask price), in a further refinement of the present invention additional methodology is required to account for these special conditions in the creation of the Second Level Oculus Data.

Accordingly, in a further refinement of the above method for creating Second Level Oculus Data, where (and when) the bid price of a traded security equals the asking price, such method comprises the steps of:

determining, for each trade in said time interval, if the ask price is equal to the bid price, and if so:

(i) determining if the traded price is greater than the ask price or bid price, and if so:
(a) calculating a first data construct (SPREAD) for such trade as being said difference between said last traded price and the bid price;
(b) calculating a second data construct (UPV) for such trade as being equal to the traded volume;
(c) calculating a third data construct (DNV) for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD;

(ii) determining if the traded price is equal to the ask price or the bid price, and if so:
(a) setting a first data construct (SPREAD) for such trade as being equal to zero;
(b) calculating a second data construct (UPV) for such trade as being equal to one-half of the traded volume;
(c) calculating a third data construct (DNV) for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD;

(iii) determining if the traded price is less than the ask price or the bid price, and if so:
(a) calculating a first data construct (SPREAD) for such trade as being the difference between said bid price and the last traded price;
(b) setting a second data construct UPV) for such trade as being equal to zero;
(c) calculating a third data construct (DNV) for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD.

Alternatively, or in addition, if the bid price is greater than the ask price, the method of the present invention for determining the Second Level Oculus Data is instead as follows:

determining, for each trade, if the bid price is greater than the ask price (bid>ask), and if so:

(i) determining if the traded price is less than the bid price and if the traded price is greater than the ask price (bid>last>ask), and if so:
(a) calculating a first data construct (SPREAD) for such trade as being said difference between said traded price and the bid price (SPREAD=bid−last);
(b) calculating a second data construct (UPV) for such trade as being equal to one-half of the traded volume (UPV=VOL/2);
(c) calculating a third data construct (DNV) for such trade as being the traded volume less the UPV (DNV=VOL−UPV);
(d) calculating a fourth data construct (NSP) for such trade by multiplying DNV×SPREAD;
(e) calculating a fifth data construct (NBP) for such trade by multiplying UPV×SPREAD;

(ii) determining if the traded price is equal to the bid price and if the traded price is greater than the ask price (last=bid>ask), and if so:
(a) calculating a first data construct (SPREAD) for such trade as said bid price less said traded price (SPREAD=bid−last);
(b) calculating a second data construct (UPV) for such trade as being equal to one-half of the traded volume (UPV=VOL/2);
(c) calculating a third data construct (DNV) for such trade as being the traded volume less the UPV (DNV=VOL−UPV);
(d) calculating a fourth data construct (NSP) for such trade by multiplying DNV×SPREAD;
(e) calculating a fifth data construct (NBP) for such trade by multiplying UPV×SPREAD;

(iii) determining if the traded price is greater than the bid price and if the traded price is greater than the ask price (last>bid>ask), and if so:
(a) calculating a first data construct (SPREAD) for such trade as being the difference between said last price and the ask price (SPREAD=last−ask);
(b) calculating a second data construct (UPV) for such trade as being equal to the traded volume (UPV=VOL);
(c) calculating a third data construct (DNV) for such trade as being the traded volume less the UPV (DNV=VOL−UPV);
(d) calculating a fourth data construct (NSP) for such trade by multiplying DNV×SPREAD;
(e) calculating a fifth data construct (NBP) for such trade by multiplying UPV×SPREAD;

(iv) determining if the traded price is equal to the ask price, and if the traded price is less than the bid price (last=ask<bid), and if so:
(a) calculating a first data construct (SPREAD) for such trade as being the difference between said bid price and the traded price (SPREAD=bid−last);
(b) calculating a second data construct (UPV) for such trade as being equal to one-half of the traded volume (UPV=VOL/2);
(c) calculating a third data construct (DNV) for such trade as being the traded volume less the UPV (DNV=VOL−UPV);
(d) calculating a fourth data construct (NSP) for such trade by multiplying DNV×SPREAD;
(e) calculating a fifth data construct (NBP) for such trade by multiplying UPV×SPREAD; and

(v) determining if the traded price is less than the ask price and if the traded price is less than the bid price (last<ask<bid), and if so:
(a) calculating a first data construct (SPREAD) for such trade as being the difference between said bid price and the traded price (SPREAD=bid−last);
(b) setting a second data construct (UPV) for such trade as being equal to zero (UPV=0);
(c) calculating a third data construct (DNV) for such trade as being the traded volume less the UPV (DNV=VOL−UPV);
(d) calculating a fourth data construct (NSP) for such trade by multiplying DNV×SPREAD;
(e) calculating a fifth data construct (NBP) for such trade by multiplying UPV×SPREAD;

If the Second Level Oculus data is calculated in accordance with one or more or all of the above methods the further data constructs RBP and RSP can be again calculated in the manner disclosed above, namely by summing each of the calculated DNV, UPV, NSP, and NBP as well as the traded volume for each trade which occurred over a defined time interval to create respectively the following data constructs SUMDNV, SUMUPV, SUMNSP, SUMNBP and SUMVOL for said defined time interval; and

calculating said data construct (RSP) for said time interval, as being:

[SUMNSP/(SUMNSP+SUMNBP)]×SUMVOL

and

calculating said data construct (RBP) for said time interval, as being:

[SUMNBP/(SUMNSP+SUMNBP)]×SUMVOL

(hereinafter “the above Method of calculating Third Level Oculus Data Constructs RBP and RSP”)

The Preferred Method for Creating Second Level Oculus Data

The present invention not only comprises the individual above methods for determining the data constructs DNV, UPV, NSP, and NBP (ie the Second Level Oculus Data), but further includes using all of the above methods, in any order and in combination, for calculating Second Level Oculus Data, to allow calculation of Second Level Oculus Data for all situations where the bid price of the traded security may be less than, equal to, or greater than, the ask price of the traded security.

Accordingly, in a preferred method for creating Second Level Oculus Data constructs DNV, UPV, NSP, and NBP (hereinafter the “Preferred Method of creating Second Level Oculus Data Constructs”), such Preferred Method of creating Second Level Oculus Data Constructs comprises:

utilizing raw-market data in respect of a plurality of consecutive trades in a traded security, such raw data including, or calculating from such raw data, a highest bid price, a lowest ask price, a traded price and a traded volume in respect of each trade in such traded security;

(A) determining, for each trade, if the bid price is less than the ask price, and if so:
(i) determining if the traded price is greater than the bid price and if the traded price is less than the ask price, and if so:
   (a) calculating a first data construct (SPREAD) with respect to such trade as being said difference between said ask price and said bid price;
   (b) calculating a second data construct (UPV) with respect to such trade as the traded price less the bid price divided by the ask price less the bid price multiplied by the traded volume;
   (c) calculating a third data construct (DNV) with respect to such trade as being the traded volume less the UPV;
   (d) calculating a fourth data construct (NSP) with respect to such trade by multiplying DNV×SPREAD;
   (e) calculating a fifth data construct (NBP) with respect to such trade by multiplying UPV×SPREAD;
(ii) determining if the traded price is equal to the ask price and if the traded price is greater than the bid price, and if so:
   (a) calculating a first data construct (SPREAD) with respect to such trade as being the difference between said ask price and said bid price;
   (b) calculating a second data construct (UPV) with respect to such trade as the traded price less the bid price divided by the ask price less that the bid price multiplied by the traded volume;
   (c) calculating a third data construct (DNV) with respect to such trade as being the traded volume less the UPV;
   (d) calculating a fourth data construct (NSP) with respect to such trade by multiplying DNV×SPREAD;
   (e) calculating a fifth data construct (NBP) with respect to such trade by multiplying UPV×SPREAD;
(iii) determining if the traded price is equal to the bid price and if the traded price is less than the ask price, and if so:
   (a) calculating a first data construct (SPREAD) with respect to such trade as being said difference between said ask price and said bid price;
   (b) calculating a second data construct (UPV) with respect to such trade as the traded price less the bid price divided by the ask price less the bid price multiplied by the traded volume;
   (c) calculating a third data construct (DNV) with respect to such trade as being the traded volume less the UPV;
   (d) calculating a fourth data construct (NSP) with respect to such trade by multiplying DNV×SPREAD;
   (e) calculating a fifth data construct (NBP) with respect to such trade by multiplying UPV×SPREAD;
(iv) determining if the traded price is less than the bid price and if the traded price is less than the ask price, and if so:
   (a) calculating a first data construct (SPREAD) with respect to such trade as being said difference between said ask price and said traded price;
   (b) setting a second data construct (UPV) with respect to such trade as being equal to zero;
   (c) calculating a third data construct (DNV) with respect to such trade as being the traded volume less the UPV;
   (d) calculating a fourth data construct (NSP) with respect to such trade by multiplying DNV×SPREAD;
   (e) calculating a fifth data construct (NBP) with respect to such trade by multiplying UPV×SPREAD;
(v) determining if the traded price is greater than the ask price and if the traded price is greater than the bid price, and if so:
   (a) calculating a first data construct (SPREAD) with respect to such trade as being said difference between said traded price and the bid price;
   (b) calculating a second data construct (UPV) with respect to such trade as being equal to the traded volume;
   (c) calculating a third data construct (DNV) with respect to such trade as being the traded volume less the UPV;
   (d) calculating a fourth data construct (NSP) with respect to such trade by multiplying DNV×SPREAD;
   (e) calculating a fifth data construct (NBP) with respect to such trade by multiplying UPV×SPREAD;

(B) determining, for each trade, if the ask price is equal to the bid price (ask=bid), and if so:

(i) determining if the traded price is greater than the ask price or bid price, and if so:
(a) calculating a first data construct (SPREAD) for such trade as being said difference between said last traded price and the bid price;
(b) calculating a second data construct (UPV) for such trade as being equal to the traded volume;
(c) calculating a third data construct (DNV for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD;

(ii) determining if the traded price is equal to the ask price or the bid price, and if so:
(a) setting a first data construct (SPREAD) for such trade as being equal to zero;
(b) calculating a second data construct (UPV) for such trade as being equal to one-half of the traded volume;
(c) calculating a third data construct (DNV) for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD;

(iii) determining if the traded price is less than the ask price or the bid price, and if so:
(a) calculating a first data construct (SPREAD) for such trade as being the difference between said bid price and the last traded price;
(b) setting a second data construct (UPV) for such trade as being equal to zero;
(c) calculating a third data construct (DNV) for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD;

(C) determining, for each trade, if the bid price is greater than the ask price, and if so:

(i) determining if the traded price is less than the bid price and if the traded price is greater than the ask price, and if so:
(a) calculating a first data construct (SPREAD) for such trade as being said difference between said bid price and the traded price;
(b) calculating a second data construct (UPV) for such trade as being equal to one-half of the traded volume;
(c) calculating a third data construct (DNV) for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD;

(ii) determining if the traded price is equal to the bid price and if the traded price is greater than the ask price, and if so:
(a) calculating a first data construct (SPREAD) for such trade as said bid price less said traded price;
(b) calculating a second data construct (UPV) for such trade as being equal to one-half of the traded volume;
(c) calculating a third data construct (DNV) for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD;

(iii) determining if the traded price is greater than the bid price and if the traded price is greater than the ask price, and if so:
(a) calculating a first data construct (SPREAD) for such trade as being the difference between said traded price and the ask price;
(b) calculating a second data construct (UPV) for such trade as being equal to the traded volume;
(c) calculating a third data construct (DNV) for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD;

(iv) determining if the traded price is equal to the ask price, and if the traded price is less than the bid price, and if so:
(a) calculating a first data construct (SPREAD) for such trade as being the difference between said bid price and the traded price;
(b) calculating a second data construct (UPV) for such trade as being equal to one-half of the traded volume;
(c) calculating a third data construct (DNV) for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD; and

(v) determining if the traded price is less than the ask price and if the traded price is less than the bid price, and if so:
(a) calculating a first data construct (SPREAD) for such trade as being the difference between said bid price and the traded price;
(b) setting a second data construct (UPV) for such trade as being equal to zero;
(c) calculating a third data construct (DNV) for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD.

As stated above, the order of conducting above steps (A), (B), and (C) may be in any order, such as for example step (C), then step (B), then step (A). However, in the above Preferred Method of creating Second Level Oculus Data Constructs set out above, such steps are conducted in the Order listed, namely (A), then (B), and then (C).

In addition, the above Preferred Method may be adapted in similar fashion to utilize data in respect of a plurality of consecutive trades in a traded security over a defined time interval, wherein such data for each trade includes a bid price, an ask price, a last traded price and a traded volume over such defined time interval. In each case the steps A, B, and C are modified, respectively, to determine the lowest and highest prices in the defined interval.

By way of example, each of steps A, B, and C, would in such circumstances be modified, so as to determine from such data the following:
(A) determining, for each time interval, if the lowest ask price is greater than the highest bid price;
(B) determining, for each time interval, if the ask price is equal to the bid price; and/or
(C) determining, for each time interval, if the bid price is greater than the ask price.

The above Preferred Methods of creating Second Level Oculus Data Constructs and then proceeding with calculating Third Level Oculus Data Constructs RBP and RSP from Second Level Oculus Data in the manner previously described above is hereinafter referred as The Preferred Method of creating Third Level Oculus Data.

Trading System

In a still-further aspect of the invention, such comprises a method of operating a trading system for a traded security using data constructs RSP and RBP (Third Level Oculus Data) calculated in accordance with the above method of calculating Third Level Oculus Data Constructs RBP and RSP from Second Level Oculus Data wherein said security is purchased when a criteria for purchasing said security includes a determination that a calculated value of RBP for said security for a particular time interval has transitioned from a value less than RSP during previous time intervals to a value greater than said RSP, and such security is sold when a criteria for purchasing said security includes a determination that a calculated value of RSP for said security for a particular time interval has transitioned from a value greater than RBP during previous time intervals to a value less than said RBP.

Backtesting, and a Trading System Using Second and/or Third Level Oculus Data and Backtesting

Backtesting of stocks (traded securities) as a manner of assisting in determining or predicting from past stock performance what such stock is likely to do in future, is well known.

However, It has been found that applying the known concept of backtesting, using historical figures for Third Level Oculus Data, surprisingly and advantageously can assist in confirming the suitability of various “trigger” criteria on when to buy or sell a security (stock) (see Examples, Detailed Description of the Invention and Preferred Embodiments, below).

Accordingly, in a further important aspect of the method of the present invention, such method comprises a method for operating a trading system for a traded security, wherein a security is purchased when a criteria for purchasing said security includes a determination that a calculated value of RBP for said security for a particular time interval has transitioned from a value less than RSP during previous time intervals to a value greater than said RSP, further comprising the step of, prior to purchasing said security, conducting at least one backtesting step comprising:

(i) retrieving previously-calculated data constructs RBP and RSP for a plurality of prior time intervals prior to a most recent time interval, hereinafter RBP(Prior) and RSP(Prior);

(ii) determining an instance within said plurality of prior time intervals prior to said most recent time interval where RSP(Prior) transitioned from less than RBP(Prior) to greater than RBP(Prior);

(iii) determining if a traded price of said security dropped immediately subsequent to said instance when RSP(Prior) transitioned from a value less than RBP(Prior) to a value greater than RBP(Prior); and

(iv) only initiating a selling of said security if said traded price of said security dropped immediately after said RSP(Prior) transitioned from less than RBP(Prior) to greater than RBP(Prior) in step (iii).

Similarly, the invention further comprises a method for operating a trading system for a traded security, wherein a security is sold when a criteria for purchasing said security includes a determination that a calculated value of RSP for said security for a particular time interval has transitioned from a value greater than RBP during previous time intervals to a value less than said RBP, further comprising the step of, prior to selling said security, conducting at least one backtesting step comprising:

(i) retrieving previously-calculated data constructs RBP and RSP for a plurality of prior time intervals prior to a most recent time interval, hereinafter RBP(Prior) and RSP(Prior) respectively;

(ii) determining an instance within said plurality of prior time intervals prior to said most recent time interval where RBP(Prior) transitioned from less than RSP(Prior) to greater than RSP(Prior);

(iii) determining if a traded price of said security rose immediately subsequent to said instance when RBP(Prior) transitioned from a value less than RSP(Prior) to greater than RSP(Prior); and

(iv) only initiating purchasing of said security if said traded price of said security rose immediately after said RSP(Prior)) transitioned from less than RBP(Prior) to greater than RBP(Prior) in step (iii).

There exist a number of known methods (technical momentum indicators), some relatively sophisticated, for determining whether to buy or sell a security, based on historical data relating to stock performance.

### (i) Relative Strength Index

The Relative Strength Index (RSI) is a common technical momentum indicator that compares the magnitude of recent gains to recent losses in an attempt to determine overbought and oversold conditions of a security. RSI is calculated using the following formula

RSI=100−[(100)/(1+RS)]

Where RS=Average (n) day's up closes/Average of (n) day's down closes.
RSI ranges between 1 and 100. Once the RSI approaches close to 70 the security is likely overbought, meaning that it is getting overvalued and is likely to decrease in price. Likewise, a level under 30 indicates that the security is likely oversold and is likely to increase in price.

### (ii) Stochastic Indicator (STO)

The Stochastic indicator (STO) is a common technical momentum indicator that compares the most recent price (value) to its price range over a given time period. The theory behind this indicator is that in upward-trending market, prices tend to close near their high and in downward-trending market prices tend to close near their low. A signal to enter or exit a trade occurs when the % K (solid line) crosses through % D (dotted line).
STO is calculated using the following formula:

%K=100×[(C−L(n))/(H(n)−L(n))]

C=the most recent Close
L=the lowest price traded for the (n) most recent sessions
H=the highest price traded for the (n) most recent sessions
% D=(n) period average of % K
N=number of periods used in the calculation
(iii) Moving Average Convergence Divergence (MACD)

Moving Average Convergence Divergence (MACD) is another commonly used momentum indicator. MACD shows the difference between a fast moving average and a slow moving average of price.

A MACD fast (6−19) moving average is calculated by subtracting the 6-day moving average from the 19-day moving average. MACD slow (6−19−9) is a smoothing line of MACD fast and is simply the 9 period average of MACD fast (6−19).

Use of Known Momentum Indicator Methods with Third Level Oculus Data

In an application of the invention, various existing momentum indicators are used for determining whether to buy or sell a security, which method uses data constructs RSP and RBP determined in accordance with the above method of calculating Third Level Oculus Data Constructs RBP and RSP from Second Level Oculus Data.

Accordingly, in a further particular aspect of the invention, the invention comprises use of stochastic method, by substituting the value of either RSP or RBP for RSP, for determining whether to buy or sell a security.

In a still further aspect of the invention, the invention comprises use of stochastic methods for determining whether to buy or sell a security, employing Third Level Oculus data when employing such methods.

In a still further aspect of the invention, the invention comprises use of a moving average convergence divergence (MACD) method of determining whether to buy or sell a security, which MACD method uses data constructs RSP and/or RBP values for determining whether to buy or sell a security.

Data Transforming and Supply System

In a further aspect of the present invention, such comprises a data transforming and supply system for transforming “raw” electronically available data in relation to one or more securities into new data constructs DNV, UPV, NSP, and NBP in accordance with the above method, and supplying such data constructs to the public for a fee. As part of such data transforming and supply system, means are provided for receiving raw data in respect of a plurality of consecutive trades in a traded security, such raw data including, or calculating from such raw data, a highest bid price, a lowest ask price, a traded price and a traded volume in respect of each trade in such traded security. Each of method steps A, B, and C are further modified to provide means for conducting the method of each of steps A, B, and C. By way of example, in the data transforming and supply system of the present invention, the following means are provided:

(A) means for determining, for each trade or for each time interval, if the bid price is less than the ask price;

(B) means for determining, for each trade or for each time interval, if the ask price equal to the bid price; and

(C) means for determining, for each trade, if the bid price is greater than the ask price.

In a further embodiment of the present invention, such data transforming and supply system further comprises determining the further data constructs in accordance with the above means/method of calculating Third Level Oculus Data Constructs RBP and RSP from Second Level Oculus Data, and supplying such data constructs to the public for a fee.

### BRIEF DESCRIPTION OF THE DRAWINGS

Further advantages and permutations and combinations of the above elements will now appear from the above and from the following detailed description of various non-limiting embodiments of the invention, taken together with the accompanying drawings, in which:

FIG. 1 is a general schematic view of the various permutations and combinations of raw data, and the various data constructs UPV, DNV, NBP and NSP which form a part of the system and method of the present invention for transforming raw data in respect of stock trades so as to create new data constructs;

FIG. 2 is a more detailed schematic than FIG. 1, showing a first method of creating the data constructs UPV, DNV, NBP, and NSP;

FIG. 3A is a detailed schematic similar to FIG. 2, showing a first portion of another alternate method for creating the data constructs UPV, DNV, NBP, and NSP;

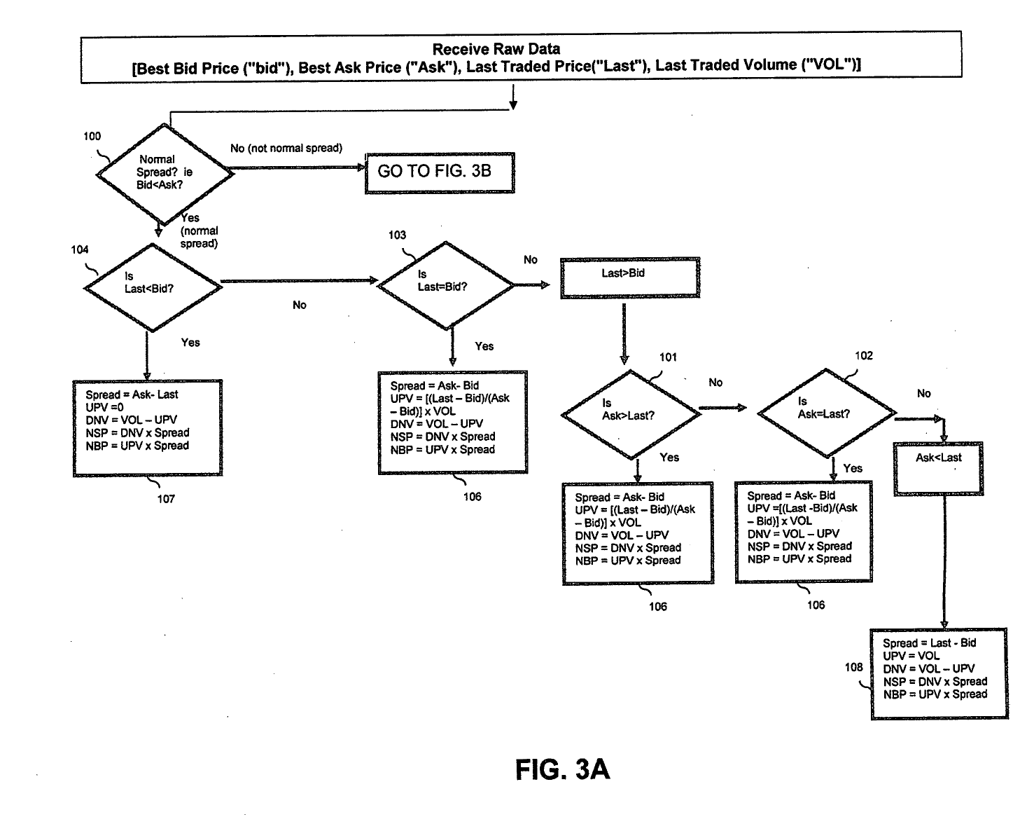

FIG. 3B is a second portion of the alternative method, a first portion of which alternate method is shown in FIG. 3A;

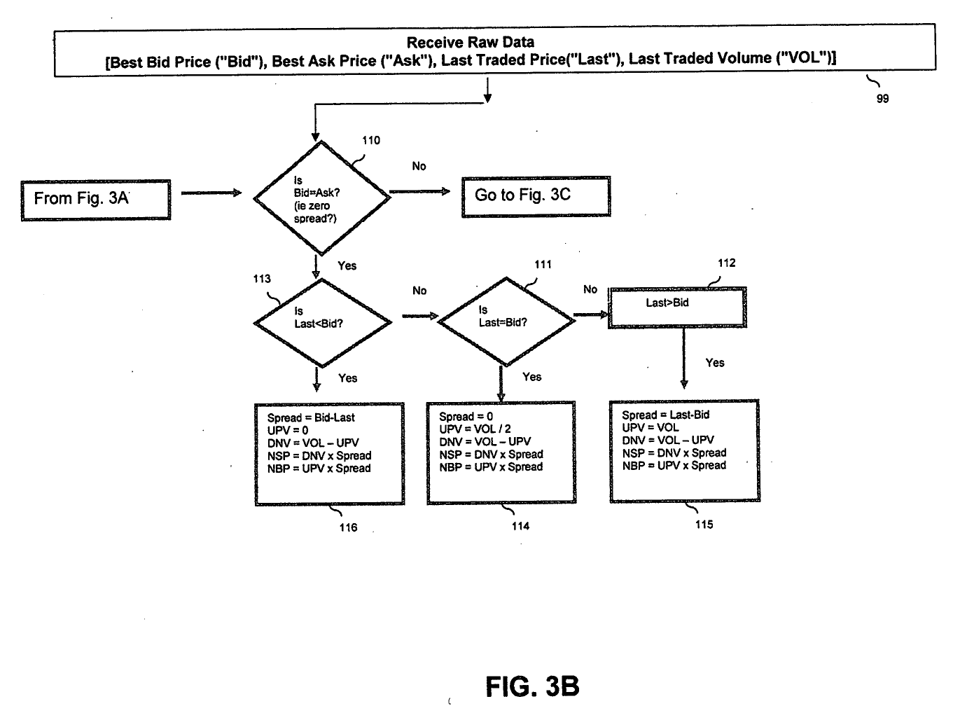

FIG. 3C is the third portion of the alternative method, first and second portions of such alternate method shown in FIGS. 3A and 3B respectively; and

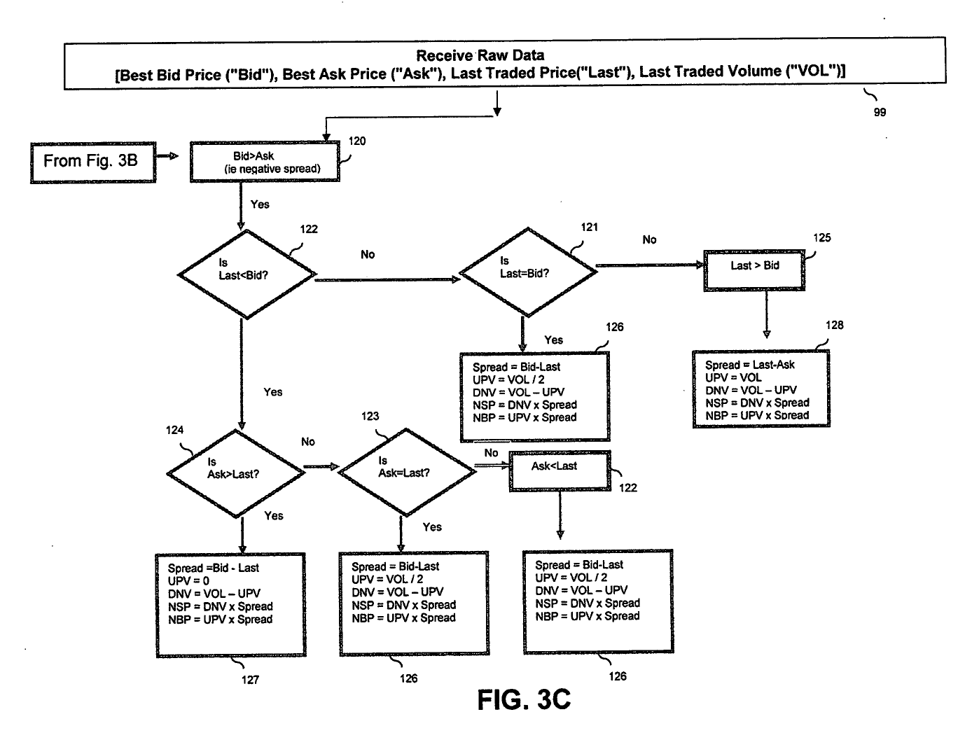

FIG. 4 is a further refinement of the present invention, conducted after the steps set out in FIG. 2, or FIGS. 3A to 3C, are conducted, wherein the additional data constructs RBP and RSP are created.

### DETAILED DESCRIPTION OF THE INVENTION AND PREFERRED EMBODIMENTS

“Raw” data comprising highest bid price (“bid), lowest ask price (“ask), last traded price (“last”), and traded volume received in respect of a publicly traded security such as a mutual fund, group of stocks, or even a single stock, has thirteen (13) permutations as to where each of bid, ask, or last exist relative to one another, namely equal to less than, or greater than the other.

TABLE 1 below sets out the various thirteen combinations of bid, ask, and last relative to each other.

TABLE I

| Bid < Ask | Bid = Ask | Bid > Ask |
|---|---|---|
| Last can be | Last can be | Last can be |
| <=> Bid | <=> Bid | <=> Bid |
| Last can be | Last can be | Last can be |
| <=> Ask | <=> Ask | <=> Ask |
| Bid < Last < Ask | Last > Bid = Ask | Bid > Last > Ask |
| Last = Ask > Bid | Last = Bid = Ask | Last = Bid > Ask |
| Last = Bid < Ask | Last < Bid = Ask | Last > Bid > Ask |
| Last < Bid < Ask | | Last = Ask < Bid |
| Last > Ask > Bid | | Last < Ask < Bid |

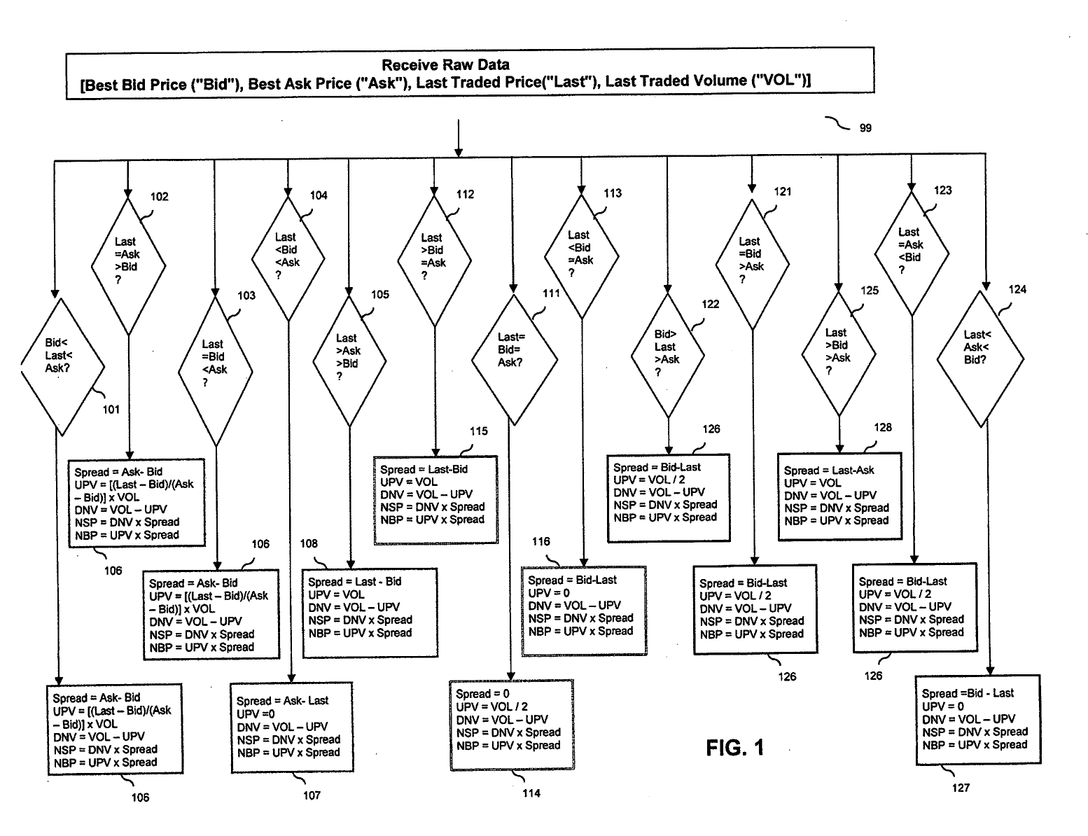

FIG. 1 of the drawings shows the manner of calculating the Second Level Oculus Data, namely the data constructs DNV, UPV, NBP, and NSP, in each of the above 13 possible scenarios (ie in scenarios 101, 102, 103, 104, 105 where ask>bid, in scenarios 111, 112, and 113 where ask=bid, and scenarios 121, 122, 123, 124, & 125 where bid>ask).

There are two fundamental concepts in the creation of Second Level Oculus Data. The first concept is allocating the volume of the trade either as UPV or DNV, depending on where the trade takes place in relation to the best Bid price and best Ask price. The second concept is calculating the spread based on the best Bid price and best Ask price and then multiplying the spread with UPV or DNV.

Specifically, boxes 106, 107, and 108 of FIG. 1 show the manner of calculating each of DNV, UPV, NBP, and NSP, namely three separate ways, depending on the associated scenarios 101, 102, 103, 104 and 105 (ie when bid<ask).

Similarly, boxes 114, 115, and 116 show the manner of calculating each of DNV, UPV, NBP, and NSP, namely three separate ways, depending on the associated scenarios 111, 112, and 113 (ie when bid=ask).

Lastly, as may also be seen from FIG. 1, boxes 126, 127, and 128 show the manner of calculating each of DNV, UPV, NBP, and NSP, namely three different ways, ways, depending on the associated scenarios 121, 122, 123, 124, and 125 (ie when bid>ask).

The strategy behind the reasons for varying the manner of calculating DNV, UPV, NBP, and NSP, depending on the relative relationship of bid price to ask price to last traded price, and why the creation of these data constructs can give further information of where the trade occurs in relation to the ask and bid price, can perhaps best be utilized from two examples.

In a first example being a situation as depicted in scenario 125 and 105 of FIG. 1 where the ask price is less than the bid price which is less than the last traded price (ie scenario 125 where last>bid>ask equivalent to ask<bid<last) and/or where the bid price is less than the ask price which is less than the last traded price (ie scenario 105 where bid<ask<last), respectively. Both are situations of strong upward direction of the headed value of the security. In both situations, the UPV (upward volume) will be at its greatest value (UPV=VOL), while the DNV (downward volume) will be at its least value (ie DNV=VOL−UPV=0). Since the spread is largest (in the case of scenario 125, as seen from Box 128, it is the largest spread ie last-ask, being greater than bid−ask or last−bid, and in the case of scenario 105 and associated box 108, the spread is likewise the largest, namely last−bid, being greater than bid−ask or last−bid), for each case the NBP which is calculated as UPV×SPREAD will be at one of its largest values, indicating a large Net Buying Pressure, while NSP calculated as DNV×SPREAD, will be at its lowest possible value, namely equal to zero, indicating the lowest Net Selling Pressure.

In a second example being a situation being a situation as depicted in scenario 124 and 113 of FIG. 1 where the last price is less than the ask price which is less than the bid (ie scenario 124 where last<ask<bid) and/or where the bid price is equal to the ask price which is greater than the last traded price (ie scenario 113 where last<bid=ask), respectively. Both are situations of a strong downward direction of the headed value of the security. In both situations, as seen from Boxes 116 and 127, the UPV (upward volume) will be at its lowest value (UPV=0), and consequently the DVN (downward volume) will be at its greatest value (ie DVN=VOL−UPV=VOL). Since the spread is largest (in the case of scenario 113, as seen from Box 116, it is the largest spread ie bid−last, being greater than bid−ask or ask−last, and in the case of scenario 124 and associated box 127 it is likewise the largest, namely bid−last, being greater than bid−ask or ask−last), for each case the NSP which is calculated as DNV×SPREAD will be at one of its largest values, indicating a large Net Selling Pressure, while NBP calculated as UPV×SPREAD, will be at its lowest possible value, namely equal to zero, indicating the lowest Net Buying Pressure.

Steps for determining which Second Level Data constructs apply for each of the 13 scenarios will now occur to a person of skill in the art, and the order of asking the series of decision “diamonds” 101, 102, 103, 104, 105, and 111, 112, 113, and 121, 122, 123, 124, & 125, to arrive at the correct Box 106, 107, 108 and 114, 115, 116 and 126, 127, and 128, respectively, will not be critical.

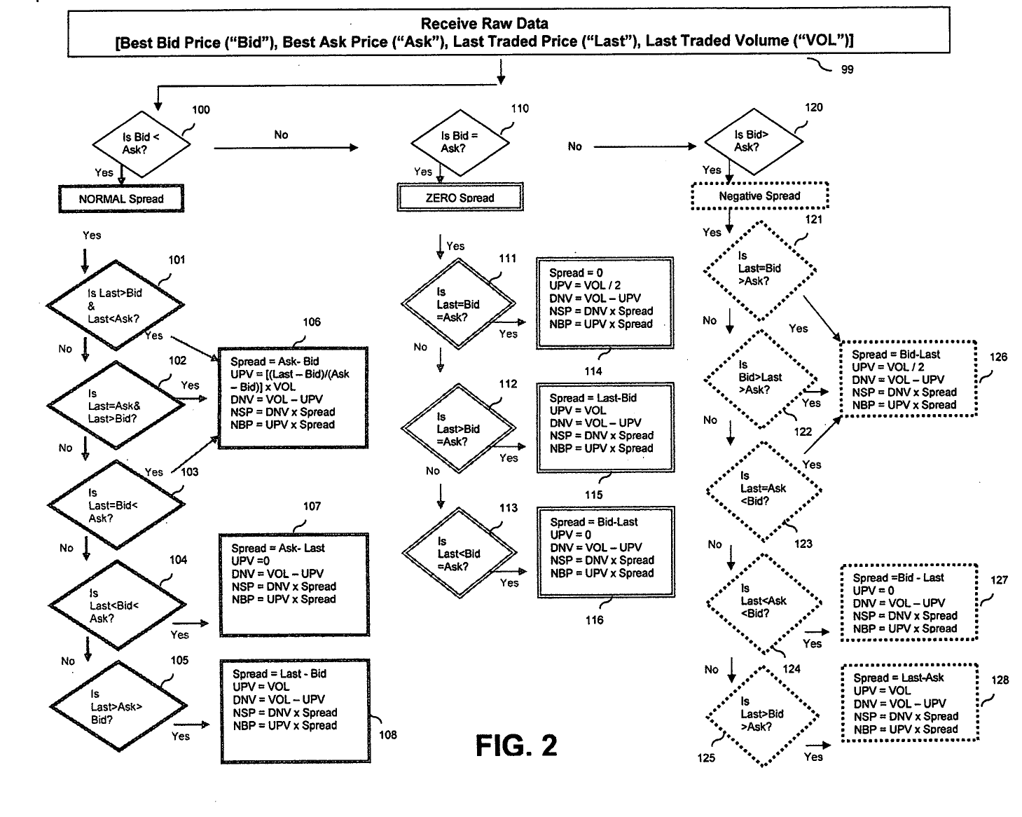

For example FIG. 2 shows one method, comprising a series of steps for asking various decision steps 101, 102, 103, 104, 105, and 111, 112, 113, and 121, 122, 123, 124, & 125, in order to arrive at the proper formula for calculating the Second Level Data Constructs UPV, DNV, NSP, and NBP. The order of the decision steps 100, 110, and 120 for initially determining whether normal spread (step 100), zero spread (step 110), or negative spread (step 120) is of course arbitrary, and any order may be used—eg step 110, then step 100, then step 120. Likewise, the order of the various decision steps 101, 102, 103, 104, 105, and 111, 112, 113, and 121, 122, 123, 124, & 125, may be altered.

Examples 3A, 3B, and 3C together show yet another manner of steps for asking various decision steps 101, 102, 103, 104, 105, and 111, 112, 113, and 121, 122, 123, 124, & 125, in order to arrive at the proper formula for calculating the Second Level Data Constructs UPV, DNV, NSP, and NBP.

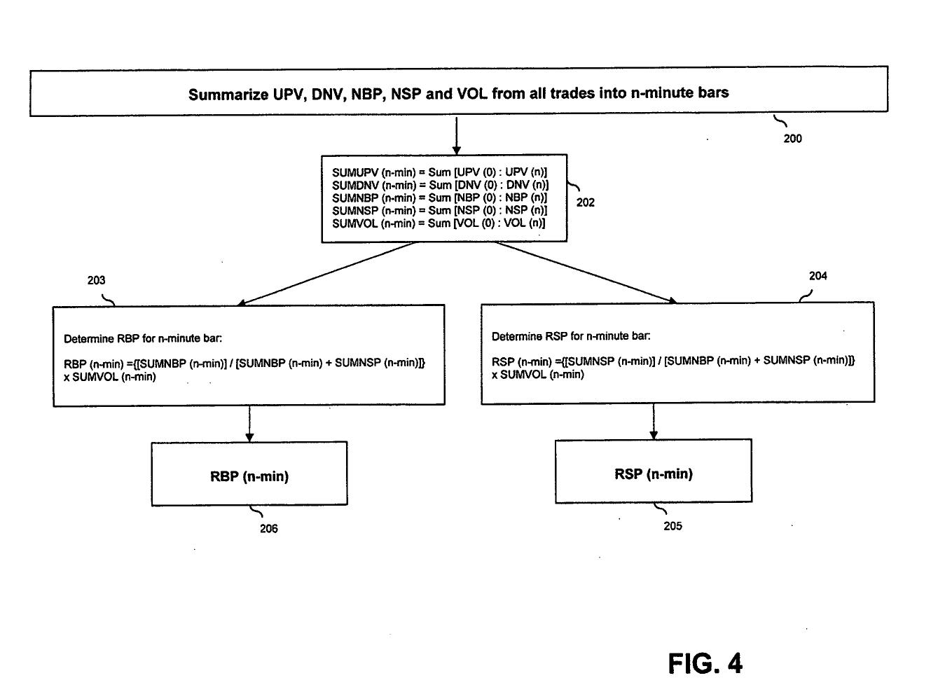

FIG. 4 shows a contemplated manner of calculating Third Level Oculus Data, namely the manner of calculating the data constructs RBP and RSP once Second Level Data Constructs DNV, UPV, NSP and NBP have been determined.

In the first step 200, UPV, DNV, NBP and VOL are summarized into n-minute bars. “n” may be one minute, 5 minute, 60 minute, 120 minute, etc may be used, but even less than one minute bars could be created if desired, provided the raw data was provided with equal frequency regarding trades.

Thereafter, in step 202, each of the calculated Second Level Oculus Data constructs are summarized over a n-minute interval as follows:

SUMUPV(n-min)=Sum[UPV (0):UPV(n)]

SUMDNV(n-min)=Sum[DNV(0):DNV(n)]

SUMNBP(n-min)=Sum[NBP(0):NBP(n)]

SUMNSP(n-min)=Sum[NSP(0):NSP(n)]

SUMVOL(n-min)=Sum[VOL(0):VOL(n)]

Thereafter, for each n-minute bar, RBP is determined as in step 203, and RSP is similarly determined for such n-minute bar, as shown in step 204, resulting in RBP (for such n-minute interval) in step 206, and RSP(for such n-minute interval) in step 205.

A more detailed explanation of the above general process is set out below.

Assuming traditional market data generated over a one minute interval as follows:
Opening price—$10.10 is defined as the first trade for the time interval occurring at 10:00:20
Highest price—$10.50 is defined as the maximum of all transaction prices for the time interval occurring at 10:00:21
Lowest price—$10.10 is defined as the minimum of all transaction prices for the time interval occurring at 10:00:20
Closing price—$10.40 is defined as the last trade price for the time interval occurring at 10:00:55.
Volume—a total of 9,000 securities were traded during the time interval 10:00:01 to 10:01:00

For all above trades, Second Level Oculus Data is calculated and then summarized in one-minute intervals. For example, TABLE III below shows generated Second Level Oculus Data Oculus Data for a 1-minute interval named 10:01

TABLE III

| Time | Name | Volume | LAST | BID | ASK | SPREAD | UPV | DNV | NBP | NSP |
|---|---|---|---|---|---|---|---|---|---|---|
| 10:00:20 | | 2,000 | $10.10 | $10.10 | $10.50 | $0.40 | 0 | 2,000 | 0 | 800 |
| 10:00:21 | | 1,000 | $10.50 | $10.00 | $10.50 | $0.50 | 1,000 | 0 | 500 | 0 |
| 10:00:42 | | 2,000 | $10.25 | $10.00 | $10.50 | $0.50 | 1,000 | 1,000 | 500 | 500 |
| 10:00:55 | | 4,000 | $10.40 | $10.30 | $10.40 | $0.10 | 4,000 | 0 | 400 | 0 |
| Total | 10:01 | 9,000 | | | | | 6,000 | 3,000 | 1,400 | 1,300 |

Calculation of Oculus Real Buying Pressure (RBP) and Real Selling Pressure (RSP)

The calculation of RBP and RSP is based on the total Net Selling Pressure (NSP) and Net Buying Pressure (NBP) for the entire bar. Since we are using a one-minute bar, RBP and RSP are calculated based on the total Volume, total NSP and total NBP for the one-minute bar. If we were using a 5-minute bar, the calculations of NSP and NBP are based on the totals of NSP and NBP for the 5-minute bar etc.

RSP and RBP are calculated based on the total sum of the Second Level Oculus Data for the particular time interval. For example, the following values from TABLE III above will be used to calculate RSP and RBP:

TABLE IV

| Time | Name | Volume | LAST | BID | ASK | SPREAD | UPV | DNV | NBP | NSP |
|---|---|---|---|---|---|---|---|---|---|---|
| Total | 10:01 | 9,000 | | | | | 6,000 | 3,000 | 1,400 | 1,300 |

The algorithm to create RBP and RSP is as follows:

RSP=[(NSP(i))/(NBP(i)+NSP(i))]×Volume(i)

Where (i) is the sum of NSP, NBP and Volume for the bar or time-interval.

RBP=[(NBP(i))/(NBP(i)+NSP(i))]×Volume(i)

Where (i) is the sum of NSP, NBP and Volume for the bar or time-interval.

For example we are using the data from TABLE IV. This data is the sum of all Oculus Level 3 Data as outlined in TABLE III. The name of the bar is 10:01

RSP=[(1,300)/(1,400+1,300)]×9,000

RBP=[(1,400)/(1,400+1,300)]×9,000

TABLE V below shows RSP and RBP for the bar named 10:01 including the Trade Data that is used in the calculation of DNV, UPV, NSP and NBP.

TABLE V
The Data used to Calculate RSP and RBP Including the Trade Data.

| Time | Volume | LAST | BID | ASK | SPREAD | UPV | DNV | NBP | NSP | RBP | RSP |
|---|---|---|---|---|---|---|---|---|---|---|---|
| 10:00:20 | 2,000 | $10.10 | $10.10 | $10.50 | $0.40 | 0 | 2,000 | 0 | 800 | | |
| 10:00:21 | 1,000 | $10.50 | $10.00 | $10.50 | $0.50 | 1,000 | 0 | 500 | 0 | | |
| 10:00:42 | 2,000 | $10.25 | $10.00 | $10.50 | $0.50 | 1,000 | 1,000 | 500 | 500 | | |
| 10:00:55 | 4,000 | $10.40 | $10.30 | $10.40 | $0.10 | 4,000 | 0 | 400 | 0 | | |
| Total | 9,000 | | | | | 6,000 | 3,000 | 1,400 | 1,300 | 4,667 | 4,333 |

TABLE VI below shows both Third Level Oculus Data and Second Level Oculus Data from the same 1-minute interval named 10:01.

TABLE VI
Historic Traditional Data and Oculus Data

| Time | Name | Volume | LAST | BID | ASK | SPREAD | UPV | DNV | NBP | NSP | RBP | RSP |
|---|---|---|---|---|---|---|---|---|---|---|---|---|
| 10:00:20 | | 2,000 | $10.10 | $10.10 | $10.50 | $0.40 | 0 | 2,000 | 0 | 800 | | |
| 10:00:21 | | 1,000 | $10.50 | $10.00 | $10.50 | $0.50 | 1,000 | 0 | 500 | 0 | | |
| 10:00:42 | | 2,000 | $10.25 | $10.00 | $10.50 | $0.50 | 1,000 | 1,000 | 500 | 500 | | |
| 10:00:55 | | 4,000 | $10.40 | $10.30 | $10.40 | $0.10 | 4,000 | 0 | 400 | 0 | | |
| Total | 10:01 | 9,000 | | | | | 6,000 | 3,000 | 1,400 | 1,300 | 4,667 | 4,333 |

| | |
|---|---|
| Open | $10.10 |
| High | $10.50 |
| Low | $10.10 |
| Close | $10.40 |
| Volume | 9,000 |

Technically, UPV, DNV, NBP and NSP are created with each trade and then stored in one-minute bars. RBP and RSP are created at the end of each one-minute bar. Data becomes historical at the completion of every one-minute bar.

Each one-minute bar contains Third Level Oculus Data for all trades that occurred during the one-minute interval. As mentioned above, time intervals (bars) less than one-minute may be contemplated where technical advances in data collection in the future provide data over intervals less than one minute. TABLE VII below shows Third Level Oculus Data summarized for a one minute interval.

TABLE VII
One-Minute Bar

| Date | Time | UPV | DNV | NBP | NSP | RBP | RSP |
|---|---|---|---|---|---|---|---|
| Aug. 22, 2008 | 10:01 | 6,000 | 3,000 | 1,400 | 1,300 | 4,667 | 4,333 |

Like historic traditional data, Third Level Oculus Data is summarized in one-minute bars. Time intervals or bars of longer periods are the sum of data contained in one-minute bars. A 5-minute bar for Third Level Oculus Data contains all of the data from the previous 5 one-minute bars.

TABLE VIII
Five-Minute Bar

| Date | Time | UPV | DNV | NBP | NSP | RBP | RSP |
|---|---|---|---|---|---|---|---|
| Aug. 22, 2008 | 10:01 | 6,000 | 3,000 | 1,400 | 1,300 | | |
| Aug. 22, 2008 | 10:02 | 2000 | 3000 | 667 | 230 | | |
| Aug. 22, 2008 | 10:03 | 8000 | 2000 | 1500 | 660 | | |
| Aug. 22, 2008 | 10:04 | 1000 | 4000 | 840 | 1100 | | |
| Aug. 22, 2008 | 10:05 | 2000 | 1000 | 220 | 112 | | |
| Aug. 22, 2008 | 10:05 | 19,000 | 13,000 | 4,627 | 3,402 | 18,441 | 13,559 |

The most common time intervals are shown in TABLE IX below. Note that Second Level Oculus Dada and Third Level Oculus Data are stored in the same manner as traditional historic data.

TABLE IX
Names of Common Bars.

| | | Data | Time | Time | Date | |
|---|---|---|---|---|---|---|
| Bar | | From | | To | | Name |
| 1 | minute bar | Aug. 22, 2008 | 9:30:01 | 9:31:00 | Aug. 22, 2008 | 9:31 |
| 5 | minute bar | Aug. 22, 2008 | 9:30:01 | 9:35:00 | Aug. 22, 2008 | 9:35 |
| 10 | minute bar | Aug. 22, 2008 | 9:30:01 | 9:40:00 | Aug. 22, 2008 | 9:40 |
| 15 | minute bar | Aug. 22, 2008 | 9:30:01 | 9:45:00 | Aug. 22, 2008 | 9:45 |
| 30 | minute bar | Aug. 22, 2008 | 9:30:01 | 10:00:00 | Aug. 22, 2008 | 10:00 |
| 60 | minute bar | Aug. 22, 2008 | 9:30:01 | 10:30:00 | Aug. 22, 2008 | 10:30 |
| 180 | minute bar | Aug. 22, 2008 | 9:30:01 | 12:30:00 | Aug. 22, 2008 | 12:30 |
| 1 | day bar | Aug. 22, 2008 | 9:30:01 | 9:30:00 | Aug. 23, 2008 | 1 day |
| 1 | week bar | Aug. 22, 2008 | 9:30:01 | 9:30:00 | Aug. 29, 2008 | 1 week |
| 1 | month bar | Aug. 1, 2008 | 9:30:01 | 9:30:00 | Sep. 9, 2008 | 1 month |
| 1 | year bar | Jan. 1, 2008 | 9:30:01 | 9:30:00 | Jan. 1, 2009 | 1 year |

Backtesting to Confirm Utility of RBP/RSP Data Constructs in Traditional Momentum Indicator Analysis Techniques

Backtesting is a key component in developing effective trading strategies. It is accomplished by reconstructing, with historical data, trades that would have occurred in the past using rules defined by the trading strategy.

In the case of the present invention, the backtesting employs using traditional indicators or custom indicators not on the “close” value of a share over a particular interval, but rather using the RBP or RSP for a share over a given time interval

A trading strategy is essentially a set of rules for entry and exit of a security. These rules are established using technical indicators. A separate set of rules is established for entering a transaction and a separate set of rules is established for exiting the transaction.

The results from backtesting offer statistics that can be used to gauge the effectiveness of the strategy. Using initial statistics, traders can optimize and improve their strategies to gain confidence in their strategy before applying it to the real markets.

Backtesting is performed using a large portfolio of securities. The larger the portfolio the more closely the results will reflect those of the entire market.

A backtest uses historical data to determine in real time if the all of the rules to enter a transaction are met (All True). Simultaneously backtesting is used to determine if any of the rules to exit a transaction are met (Any True).

Backtesting Example

A typical trading strategy, using each of the Relative Strength Index momentum indicator (RSI), and the traditional stochastic method % K, % D (hereinafter “STO”) as another momentum indicator, would be as follows:

Enter a transaction long if (All True in Buy Strategy)

| | | |
|---|---|---|
| [Indicator #1] | STO % K, (1 day) % K > STO % D, (1 day) | is True |
| [Indicator #2] | RSI (Close), (1 day) <30 | is True |
| [Indicator #3] | RSI (Close), (60 min) <30 | is True |

Exit a transaction long if (Any True in Sell Strategy)

| | | |
|---|---|---|
| [Indicator #4] | RSI, (Close), (1 day) >70 | is True |
| [Indicator #5] | RSI, (Close), (60 min) >80 | is True |

In such above example (Indicator #1) STO % K uses the traditional historical data (highest price, lowest price, and closing price) as the data input, using the traditional momentum indicator formula for % K, namely:

%K=[recent close−lowest low (n)]/[highest high (n)−lowest low (n)]×100

while % D is determined by the following formula:

%D=(n) period average of %K

A backtesting test, using Exxon Mobil shares (“XOM”) and one hour time intervals over the period 10:30 am Aug. 22, 2008 to 4:00 pm (16:00 on the 24 hour clock), was employed using this above trading strategy, to show the manner of backtesting contemplated by the invention. TABLE X below shows the individual results for each indicator (ie 1, 2, 3,and 4) for every 1-hour bar.

As may be seen from the below TABLE X, on 8/22/2008, technical indicator #1 was FALSE until 8/23/2008 10:30 when this technical indicator turned from FALSE to TRUE. At 8/23/2008 10:30, all technical indicators were TRUE which resulted in the purchase of 500 shares of XOM at $66.95.

As may also be seen from TABLE X below, on 8/23/2008 14:30, technical indicator #5 turned from FALSE to TRUE that resulted in the sale of 500 shares of XOM at $68.70. The profit on this transaction was $875.

TABLE X
Backtesting example

| | | | | | Buy Strategy | | | Sell Strategy | |
|---|---|---|---|---|---|---|---|---|---|
| Symbol | Date | Time | Price | Shares | Ind: #1 | Ind: #2 | Ind: #3 | Ind: #4 | Ind: #5 |
| XOM | Aug. 22, 2008 | 10:30 | 69.00 | | FALSE | TRUE | TRUE | FALSE | FALSE |
| XOM | Aug. 22, 2008 | 11:30 | 68.36 | | FALSE | TRUE | TRUE | FALSE | FALSE |
| XOM | Aug. 22, 2008 | 12:30 | 66.35 | | FALSE | TRUE | TRUE | FALSE | FALSE |
| XOM | Aug. 22, 2008 | 13:30 | 66.89 | | FALSE | TRUE | TRUE | FALSE | FALSE |
| XOM | Aug. 22, 2008 | 14:30 | 66.20 | | FALSE | TRUE | TRUE | FALSE | FALSE |
| XOM | Aug. 22, 2008 | 15:30 | 65.90 | | FALSE | TRUE | TRUE | FALSE | FALSE |
| XOM | Aug. 22, 2008 | 16:00 | 66.35 | | FALSE | TRUE | TRUE | FALSE | FALSE |
| XOM | Aug. 23, 2008 | 10:30 | 66.95 | 500 | TRUE | TRUE | TRUE | FALSE | FALSE |
| XOM | Aug. 23, 2008 | 11:30 | 68.20 | | TRUE | TRUE | TRUE | FALSE | FALSE |
| XOM | Aug. 23, 2008 | 12:30 | 69.15 | | TRUE | TRUE | TRUE | FALSE | FALSE |
| XOM | Aug. 23, 2008 | 13:30 | 68.90 | | TRUE | TRUE | TRUE | FALSE | FALSE |
| XOM | Aug. 23, 2008 | 14:30 | 68.70 | −500 | TRUE | TRUE | FALSE | FALSE | TRUE |
| XOM | Aug. 23, 2008 | 15:30 | 67.10 | | TRUE | TRUE | FALSE | FALSE | TRUE |
| XOM | Aug. 23, 2008 | 16:00 | 66.40 | | TRUE | TRUE | FALSE | FALSE | TRUE |
| RESULT | | | | | | | | | |
| BUY | Aug. 23, 2008 | 10:30 | 66.95 | 500 | | | | | |
| SELL | Aug. 23, 2008 | 14:30 | 68.7 | −500 | | | | | |
| Profit/Loss | | | $875.00 | | | | | | |

Real-Time Analysis of Trading Strategies

Historical data is received in real-time and then analyzed against a specific trading strategy in real-time to determine if the security should be bought or sold. Once this determination has been made, the buy or sell order is sent to an Internet based broker who executes the trade.

Historical data is created with each trade and then is updated in real time and then stored in one-minute intervals called bars. For our purposes, the data becomes historical at the completion of every one-minute bar. This means that a new 1-minute bar is created every minute. Similarly a new 5-minute bar is created every 5 minutes and so forth for other time intervals.

Real-Time Analysis using Various Trading Strategies

Real-time analysis of trading strategies is essentially backtesting in real time.

Since new historical data is created with the completion of a new bar, real time analysis is undertaken based on the smallest time interval contained in the strategy. For example if the trading strategy uses 1-day data and 60-minute data, the real time analysis is performed every 60 minutes based on the latest data contained in the last 60-minute bar. Obviously, there is no benefit in analyzing the data every minute because the data for the 60-minute bar does not change until the end of the 60-minute period. Similarity a trading strategy that used 5-minute data would have to be analyzed every 5 minutes.

Current positions are transactions where a party has previously bought a security but has not sold it. These current positions are tested every hour to determine if any of the rules to exiting a trade are TRUE. Here we are testing the sell strategy indicators to determine if any are TRUE.

Possible new transactions are tested every hour to determine if all of the rules to enter a trade are TRUE. The buy strategy indicators are calculated at the end of every hour to determine if all are TRUE.

### Example 1

The above Method of calculating Third Level Oculus Data Constructs RBP and RSP was employed, and the resultant data constructs RBP and RSP were tested in three separate trading strategies (a), (b), and (c), namely:
(a) entering a security transaction (ie buy a stock-LONG) if the calculated value of RBP for said stock for a particular time interval (1 day preceding) has transitioned from a value less than RSP during previous 1 day time intervals to a value greater than said RSP (ie calculated RBP>RSP), and further exiting a securities transaction (ie selling to close the transaction-) when a calculated value of RBP for said stock for a 1 day preceding period has transitioned from a value greater than RSP during previous 1 day time intervals to a value less than said RSP (ie RBP<RSP); and
entering a security transaction (ie sell a stock-SHORT) if the calculated value of RBP for said stock for a particular time interval (1 day preceding) has transitioned from a value greater than RSP during previous 1 day time intervals to a value less than said RSP (ie calculated RBP<RSP), and further exiting a securities transaction (ie buying to close the transaction) when a calculated value of RBP for said stock for a 1 day preceding period has transitioned from a value less than RSP during previous 1 day time intervals to a value greater than said RSP (ie RBP>RSP);
(b) a modified stochastic approach, using % K and % D which traditionally uses the stock “close” price at the end of a day, namely:

%K=[recent close−lowest low (n)]/[highest high (n)−lowest low (n)]×100, and

%D=(n) period average of %K
and instead modifying such traditional stochastic approach, so as to calculate % K as follows:

%K=[recent RBP−lowest RBP(n)]/[highest RBP(n)−lowest RBP(n)]×100 and

%D=(n) period average of %K
Specifically, the trading strategy used for “SHORT” is:
Enter Short: If Stochastic % K (RBP), 1 day<Stochastic % D (RBP), 1 day
Exit Short: If Stochastic % K (RBP), 1 day>Stochastic % D (RBP), 1 day
Specifically, the trading strategy used for “LONG” is:
   Enter Long: If Stochastic % K (RBP), 1 day>Stochastic % D (RBP), 1 day
   Exit Long: If Stochastic % K (RBP), 1 day<Stochastic % D (RBP), 1 day
(c) a modified Moving Average Convergence Divergence (MACD) momentum indicator analysis, which traditionally uses a six period moving average, and a 19 period moving average, and producing therefrom a 9 period average, and modifying such approach to use Third Level Oculus Data RBP and RSP, as follows:
   The Modified MACD trading strategy used for “LONG” is:
   Enter Long: If MACD (6−19), (RBP), 1 day>MACD (6−19−9), (RBP), 1 day
   Exit Long: If MACD (6−19), (RBP), 1 day<MACD (6−19−9), (RBP), 1 day
   The Modified MACD trading strategy used for “SHORT” is:
   Enter Short: If MACD (6−19), (RBP), 1 day<MACD (6−19−9), (RBP) 1 day
   Exit Short: If MACD (6−19), (RBP), 1 day>MACD (6−19−9), (RBP) 1 day

Results from the above 3 trading strategies using Third Level Oculus Data were compared with two traditional trading methods, namely:
(d) a stochastic method, based on daily “close” price of a share, as follows:
   Specifically, the traditional stochastic trading strategy used for “SHORT” was:

Enter Short: If Stochastic % K (Close), 1 day<Stochastic % D (Close) Close, 1 day

Exit Short: If Stochastic % K (Close), 1 day>Stochastic % D (Close) Close, 1 day
Specifically, the traditional stochastic trading strategy used for “LONG” was:

Enter Long: If Stochastic % K (Close), 1 day>Stochastic % D (Close), 1 day

Exit Long: If Stochastic % K (Close), 1 day<Stochastic % D (Close), 1 day
and
(e) a moving average convergence divergence (MACD) method, using a six period moving average, and a 19 period moving average, and producing from such results a 9 period average. MACD shows the difference between a fast moving average and a slow moving average of price. As hereinafter explained the MACD method used herein used MACD (6−19) as the fast moving average and (6−19−9) as the slow moving average.
MACD fast (6−19) is calculated by subtracting the 6-day moving average from the 19-day moving average. MACD slow (6−19−9) is a smoothing line of MACD fast and is simply the 9 period average of MACD fast (6−19).

Specifically, the traditional MACD trading strategy used for “SHORT” was:
Enter Short: If MACD (6−19), (Close), 1 day<MACD (6−19−9), (Close) 1 day
Exit Short: If MACD (6−19), (Close), 1 day>MACD (6−19−9), (Close) 1 day

Specifically, the traditional MACD trading strategy used for “LONG” was:
Enter Long: If MACD (6−19), (Close), 1 day>MACD (6−19−9), (Close), 1 day
Exit Long: If MACD (6−19), (Close), 1 day<MACD (6−19−9), (Close), 1 day

The above three trading strategies (a)-(c) using the Third Level Oculus Data in the manner above specified, and the two traditional two methods (e) & (f) (ie Stochastic and MACD) using traditional approaches as above specified, were all backtested on a well known stock portfolio, namely the “S&P” index consisting of 500 stocks.

In addition to using the S&P index, over 3000 selected market stocks, selected from the approximately 14,000 stocks that are listed for trading on all US and Canadian exchanges, were selected as a stock portfolio for evaluation purposes. It is important to use a large portfolio of securities for backtesting, because the larger the portfolio the more closely the results will reflect the entire market. The stocks selected to form the marked portfolio for the market comparison were those stocks with an average daily trading volume of greater than 300,000 and a share price of greater than $10.00. This total amounted to 3236 stocks. In other words, eliminated from approximately 14000 market stocks were approximately 10,764 stocks that did not meet either one or both of the two requirements of average volume or stock price. Such stock portfolio is hereinafter referred to as “MKT”.

The purpose of selecting the above two stock portfolios (hereinafter S&P 500 and MKT) was in order to obtain quantitative results comparing the efficacy of the Method of calculating Third Level Oculus Data Constructs RBP and RSP of the present invention in comparison to traditional momentum indicator methods (stochastic, and MACD) using the stocks for each of the above two stock portfolios (ie S&P 500, and MKT).

The start date for each backtest was the same (Sep. 1, 2007), as was the end date for each of the backtest, namely Feb. 28, 2009.

TABLE XI below sets out the results of the first trading system (a) above set out using Third Level Oculus Data, namely the data constructs RSP and RBP:

TABLE XI

| Indicator | Porfolio | # Securities | Data Input | Profit (Loss) | % Return | # Trades | % Profitable |
|---|---|---|---|---|---|---|---|
| RBP > RSP | S & P 500 | 500 LONG | RBP, RSP | ($2,437,220) | −27.17% | 41,775 | 46.31% |
| RSP > RBP | S & P 500 | 500 SHORT | RBP, RSP | $3,270,693 | 38.04% | 39,115 | 52.54% |
| Combined | | | | $833,473 | 5.43% | 80,890 | 49.32% |

Using such (first) trading strategy using Third Level Oculus Data, there was 41,775 trades of which 19,346 trades were profitable representing 46.31%

As may be seen from the above TABLE XI, a profit of $833,473 was realized over such period, using the first trading system (a) using Third Level Oculus Data. A profitable trade was defined as one where the difference between what the security was sold for and what the security was bought for (including commissions of $0.01/share) was positive ie Price (Sold)>Price (Bought).

TABLE XII below summarizes, in the first set of two entries, the results obtained respectively for the traditional stochastic method [ie trading method (d) LONG], and compares such with trading method (b) LONG using modified stochastic methods using Third Level Oculus Data. As may be seen, the modified Stochastic method [ie trading method (b) LONG] resulted in profitable trades 47.00% of the time as compared to the traditional stochastic method [ie trading method (d) LONG], which only resulted in profitable trades 29.03% of the time. It is further noted that trading scheme (a) LONG using Third Level Oculus Data, in comparison, was profitable 46.31% of the time as seen from TABLE XI above.

TABLE XII below further summarizes, in the second set of two entries, the results obtained respectively for the traditional stochastic method [ie trading method (d) SHORT], and compares such with auto-trading method (b) SHORT using modified stochastic methods using Third Level Oculus Data. As may be seen, the modified Stochastic method [ie trading method (b) SHORT] resulted in profitable trades 54.24% of the time, as compared to the traditional stochastic method [ie trading method (d) SHORT], which only resulted in profitable trades 35.69% of the time. It Is further noted that trading method (a) SHORT using Third Level Oculus Data, in comparison, was profitable 52.54% of the time as seen from TABLE XI above.

TABLE XII below further summarizes, in the third set of two entries, the results obtained respectively for the traditional MACD method [ie trading method (e) LONG], and compares such with trading method (c) LONG using modified stochastic methods using Third Level Oculus Data. As may be seen, the modified Stochastic method [ie trading method (b) SHORT] resulted in profitable trades 54.24% of the time, as compared to the traditional stochastic method [ie trading method (d) SHORT], which only resulted in profitable trades 35.69% of the time.

TABLE XII below further summarizes, in the fourth set of two entries, the results obtained respectively for the traditional MACD method [ie trading method (e) SHORT], and compares such with trading method (c) SHORT using modified stochastic methods using Third Level Oculus Data. As may be seen, the modified Stochastic method [ie trading method (b) SHORT] resulted in profitable trades 53.86% of the time, as compared to the traditional stochastic method [ie trading method (e) SHORT], which only resulted in profitable trades 33.44% of the time.

TABLE XII

| Indicator | Portfolio | # Securities | Data Input | Profit (Loss) | % Return | # Trades | % Profitable |
|---|---|---|---|---|---|---|---|
| STO | S & P 500 | 500 LONG | Close | ($6,351,795) | −58.43% | 26,004 | 29.03% |
| STO | S & P 500 | 500 LONG | RBP | ($1,987,311) | −23.52% | 33,990 | 47.00% |
| STO | S & P 500 | 500 SHORT | Close | ($612,089) | −8.99% | 24,194 | 35.69% |
| STO | S & P 500 | 500 SHORT | RBP | $3,677,846 | 40.49% | 31,890 | 54.24% |
| MACD | S & P 500 | 500 LONG | Close | ($4,765,645.00) | −48.33% | 10,291 | 25.91% |
| MACD | S & P 500 | 500 LONG | RBP | ($2,838,608.00) | −32.16% | 19,780 | 45.18% |
| MACD | S & P 500 | 500 SHORT | Close | $511,846.00 | 6.54% | 9,456 | 33.44% |
| MACD | S & P 500 | 500 SHORT | RBP | $2,789,033.00 | 31.86% | 18,570 | 53.86% |

In summary, as may be seen from both of Tables XI and XII above, using the S& P index, trading methods employing Third Level Oculus Data (namely trading methods (a), (b) and (c) in every case resulted in higher percentages of profitable trades being made than did the more traditional trading methods which did not employ Third Level Oculus Data constructs [ie methods (d) and (e)]

In like manner, similar results were obtained using the MKT portfolio described above over the identical time interval from Sep. 1, 2007 to Feb. 28, 2009. Identical comparisons were made, and the results are tabulated in TABLE XIII below:

TABLE XIII

| | | | | | | | |
|---|---|---|---|---|---|---|---|
| STO | MKT | 3236 LONG | Close | ($17,812,857) | −53.01% | 105,058 | 30.71% |
| STO | MKT | 3236 LONG | RBP | ($6,659,771) | −24.94% | 137,426 | 47.26% |
| STO | MKT | 3236 SHORT | Close | $2,315,341 | 9.45% | 88,128 | 37.55% |
| STO | MKT | 3236 SHORT | RBP | $12,836,213 | 41.88 | 117,063 | 54.58% |
| MACD | MKT | 3236 LONG | Close | ($14,693,508.00) | −46.39% | 42,001 | 27.78% |
| MACD | MKT | 3236 LONG | RBP | ($9,068,390.00) | −31.84% | 79,144 | 45.88% |
| MACD | MKT | 3236 SHORT | Close | $3,215,341.00 | 9.45% | 88,128 | 37.55% |
| MACD | MKT | 3236 SHORT | RBP | $12,836,213.00 | 41.88% | 117,063 | 54.69% |

As may similarly be seen from TABLE XIII above, trading methods employing Third Level Oculus Data (namely trading methods (b) and (c) in every case resulted in higher percentages of profitable trades being made than did the more traditional trading methods which did not employ Third Level Oculus Data constructs. The MKT portfolio, comprising over 3000 stocks and thus being a large representative sample, produces a very true and accurate result as to the improvement in using Third Level Oculus Data of the present invention over traditional trading methods.

While the disclosure and drawings describe and illustrate preferred embodiments the invention, it is to be understood that the invention is not limited to these particular embodiments. Many variations and modifications will now occur to those skilled in the art. For a complete definition of the invention and its intended scope, reference is to be made to the summary of the invention and the appended claims read together with and considered with the disclosure and drawings herein.

I claim:

1. A method of transforming trading data for a traded security so as to create new financial data constructs DNV, UPV, NBP, and NSP in respect of trades in such traded security, comprising:
utilizing raw market data in respect of a plurality of consecutive trades in a traded security, such raw data including, or calculating from such raw data, a highest bid price, a lowest ask price, a traded price and a traded volume in respect of each trade in such traded security;
determining, for each trade, if the bid price is less than the ask price (bid<ask), and if so:
(i) determining if the traded price is greater than the bid price and if the traded price is less than the ask price (bid<last<ask), and if so:
(a) calculating a first data construct (SPREAD) with respect to such trade as being said difference between said ask price and said bid price (SPREAD=ask−bid);
(b) calculating a second data construct (UPV) with respect to such trade as the traded price less the bid price divided by the ask price less the bid price multiplied by the traded volume (UPV={[last−bid]/[ask−bid]}×VOL);
(c) calculating a third data construct (DNV) with respect to such trade as being the traded volume less the UPV (DNV=VOL−UPV);
(d) calculating a fourth data construct (NSP) with respect to such trade by multiplying DNV×SPREAD;
(e) calculating a fifth data construct (NBP) with respect to such trade by multiplying UPV×SPREAD;
(ii) determining if the traded price is equal to the ask price and if the traded price is greater than the bid price (last=ask>bid), and if so:
(a) calculating a first data construct (SPREAD) with respect to such trade as being the difference between said ask price and said bid price(SPREAD=ask−bid);
(b) calculating a second data construct (UPV) with respect to such trade as the traded price less the bid price divided by the ask price less that the bid price multiplied by the traded volume (UPV={[last−bid]/[ask−bid]}×VOL);
(c) calculating a third data construct (DNV) with respect to such trade as being the traded volume less the UPV (DNV=VOL−UPV);
(d) calculating a fourth data construct (NSP) with respect to such trade by multiplying DNV×SPREAD;
(e) calculating a fifth data construct (NBP) with respect to such trade by multiplying UPV×SPREAD;
(iii) determining if the traded price is equal to the bid price and if the traded price is less than the ask price (last=bid<ask), and if so:
(a) calculating a first data construct (SPREAD) with respect to such trade as being said difference between said ask price and said bid price (SPREAD=ask−bid);
(b) calculating a second data construct (UPV) with respect to such trade as the traded price less the bid price divided by the ask price less the bid price multiplied by the traded volume (UPV={[last−bid]/[ask−bid]}×VOL);
(c) calculating a third data construct (DNV) with respect to such trade as being the traded volume less the UPV (DNV=VOL−UPV);
(d) calculating a fourth data construct (NSP) with respect to such trade by multiplying DNV×SPREAD;
(e) calculating a fifth data construct (NBP) with respect to such trade by multiplying UPV×SPREAD;
(iv) determining if the traded price is less than the bid price and if the traded price is less than the ask price (last<bid<ask), and if so:
(a) calculating a first data construct (SPREAD) with respect to such trade as being said difference between said ask price and said traded price (SPREAD=ask−last);
(b) setting a second data construct (UPV) with respect to such trade as being equal to zero (UPV=0);
(c) calculating a third data construct (DNV) with respect to such trade as being the traded volume less the UPV (DNV=VOL−UPV);
(d) calculating a fourth data construct (NSP) with respect to such trade by multiplying DNV×SPREAD;
(e) calculating a fifth data construct (NBP) with respect to such trade by multiplying UPV×SPREAD;
(v) determining if the traded price is greater than the ask price and if the traded price is greater than the bid price (last>ask>bid), and if so:
(a) calculating a first data construct (SPREAD) with respect to such trade as being said difference between said traded price and the bid price (SPREAD=last−bid);
(b) calculating a second data construct (UPV) with respect to such trade as being equal to the traded volume (UPV=VOL);
(c) calculating a third data construct (DNV) with respect to such trade as being the traded volume less the UPV (DNV=VOL−UPV);
(d) calculating a fourth data construct (NSP) with respect to such trade by multiplying DNV×SPREAD;
(e) calculating a fifth data construct (NBP) with respect to such trade by multiplying UPV×SPREAD.

2. The method of claim 1, further comprising the steps of creating further data constructs RBP and RSP, comprising the steps of:
summing each of the calculated DNV, UPV, NSP, and NBP as well as the traded volume for each trade which occurred over a defined time interval to create respectively the following data constructs SUMDNV, SUMUPV, SUMNSP, SUMNBP and SUMVOL for said defined time interval; and
calculating said data construct (RSP) for said time interval, as being:
[SUMNSP/(SUMNSP+SUMNBP)]×SUMVOL
and
calculating said data construct (RBP) for said time interval, as being:
[SUMNBP/(SUMNSP+SUMNBP)]×SUMVOL

3. The method of claim 1, further comprising the step of:
determining for each trade if the bid price is equal to the ask price (bid=ask), and if so:
(i) determining if the traded price is greater than the ask price or bid price (last>bid=ask), and if so:
(a) calculating a first data construct (SPREAD) for such trade as being said difference between said last traded price and the bid price (SPREAD=last−bid);
(b) calculating a second data construct (UPV) for such trade as being equal to the traded volume (UPV=VOL);
(c) calculating a third data construct (DNV) for such trade as being the traded volume less the UPV (DNV=VOL−UPV);
(d) calculating a fourth data construct (NSP) for such trade by multiplying DNV×SPREAD;
(e) calculating a fifth data construct (NBP) for such trade by multiplying UPV×SPREAD;
(ii) determining if the traded price is equal to the ask price or the bid price (last=bid=ask), and if so:
(a) setting a first data construct (SPREAD) for such trade as being equal to zero (SPREAD=0);
(b) calculating a second data construct (UPV) for such trade as being equal to one-half of the traded volume over said time interval (UPV=VOL/2);
(c) calculating a third data construct (DNV) for such trade as being the traded volume less the UPV (DNV=VOL−UPV);
(d) calculating a fourth data construct (NSP) for such trade by multiplying DNV×SPREAD;
(e) calculating a fifth data construct (NBP) for such trade by multiplying UPV×SPREAD;
(iii) determining if the traded price is less than the ask price or the bid price (last<bid=ask), and if so:
(a) calculating a first data construct (SPREAD) for such trade as being the difference between said bid price and the last traded price (bid−last);
(b) setting a second data construct (UPV) for such trade as being equal to zero (UPV=0);
(c) calculating a third data construct (DNV) for such trade as being the traded volume less the UPV (DNV=VOL−UPV);
(d) calculating a fourth data construct (NSP) for such trade by multiplying DNV×SPREAD;
(e) calculating a fifth data construct (NBP) for such trade by multiplying UPV×SPREAD.

4. The method of claim 3, further comprising the steps of creating further data constructs RBP and RSP, comprising the steps of:
summing each of the calculated DNV, UPV, NSP, and NBP as well as the traded volume for each trade which occurred over a defined time interval to create respectively the following data constructs SUMDNV, SUMUPV, SUMNSP, SUMNBP and SUMVOL for said defined time interval; and
calculating said data construct (RSP) for said time interval, as being:
[SUMNSP/(SUMNSP+SUMNBP)]×SUMVOL
and
calculating said data construct (RBP) for said time interval, as being:
[SUMNBP/(SUMNSP+SUMNBP)]×SUMVOL

5. The method of claim 1, further comprising the step of:
determining, for each trade, if the bid price is greater than the ask price (bid>ask), and if so:
(i) determining if the traded price is less than the bid price and if the traded price is greater than the ask price (bid>last>ask), and if so:
(a) calculating a first data construct (SPREAD) for such trade as being said difference between said bid price and the traded price (SPREAD=bid−last);
(b) calculating a second data construct (UPV) for such trade as being equal to one-half of the traded volume (UPV=VOL/2);
(c) calculating a third data construct (DNV) for such trade as being the traded volume less the UPV (DNV=VOL−UPV);
(d) calculating a fourth data construct (NSP) for such trade by multiplying DNV×SPREAD;
(e) calculating a fifth data construct (NBP) for such trade by multiplying UPV×SPREAD;
(ii) determining if the traded price is equal to the bid price and if the traded price is greater than the ask price (last=bid>ask), and if so:
(a) calculating a first data construct (SPREAD) for such trade as said bid price less said traded price (SPREAD=bid−last);
(b) calculating a second data construct (UPV) for such trade as being equal to one-half of the traded volume (UPV=VOL/2);
(c) calculating a third data construct (DNV) for such trade as being the traded volume less the UPV (DNV=VOL−UPV);
(d) calculating a fourth data construct (NSP) for such trade by multiplying DNV×SPREAD;
(e) calculating a fifth data construct (NBP) for such trade by multiplying UPV×SPREAD;
(iii) determining if the traded price is greater than the bid price and if the traded price is greater than the ask price (last>bid>ask), and if so:
(a) calculating a first data construct (SPREAD) for such trade as being the difference between said traded price and the ask price (SPREAD=last−ask);
(b) calculating a second data construct (UPV) for such trade as being equal to the traded volume (UPV=VOL);
(c) calculating a third data construct (DNV) for such trade as being the traded volume less the UPV (DNV=VOL−UPV);
(d) calculating a fourth data construct (NSP) for such trade by multiplying DNV×SPREAD;
(e) calculating a fifth data construct (NBP) for such trade by multiplying UPV×SPREAD;
(iv) determining if the traded price is equal to the ask price, and if the traded price is less than the bid price (last=ask<bid), and if so:
(a) calculating a first data construct (SPREAD) for such trade as being the difference between said bid price and the traded price (SPREAD=bid−last);
(b) calculating a second data construct (UPV) for such trade as being equal to one-half of the traded volume (UPV=VOL/2);
(c) calculating a third data construct (DNV) for such trade as being the traded volume less the UPV (DNV=VOL−UPV);
(d) calculating a fourth data construct (NSP) for such trade by multiplying DNV×SPREAD;
(e) calculating a fifth data construct (NBP) for such trade by multiplying UPV×SPREAD; and
(v) determining if the traded price is less than the ask price and if the traded price is less than the bid price (last<ask<bid), and if so:
(a) calculating a first data construct (SPREAD) for such trade as being the difference between said bid price and the traded price (SPREAD=bid−last);
(b) setting a second data construct (UPV) for such trade as being equal to zero (UPV=0);
(c) calculating a third data construct (DNV) for such trade as being the traded volume less the UPV (DNV=VOL−UPV);
(d) calculating a fourth data construct (NSP) for such trade by multiplying DNV×SPREAD;
(e) calculating a fifth data construct (NBP) for such trade by multiplying UPV×SPREAD;

6. The method of claim 5, further comprising the steps of creating further data constructs RBP and RSP, comprising the steps of:
summing each of the calculated DNV, UPV, NSP, and NBP as well as the traded volume for each trade which occurred over a defined time interval to create respectively the following data constructs SUMDNV, SUMUPV, SUMNSP, SUMNBP and SUMVOL for said defined time interval; and
calculating said data construct (RSP) for said time interval, as being:
[SUMNSP/(SUMNSP+SUMNBP)]×SUMVOL
and
calculating said data construct (RBP) for said time interval, as being:
[SUMNBP/(SUMNSP+SUMNBP)]×SUMVOL

7. A method of transforming existing trading data for a traded security so as to create new financial data constructs NSP, NBP, DNV and UPV, comprising:
utilizing raw market data in respect of a plurality of consecutive trades in a traded security, such raw data including, or calculating from such raw data, a highest bid price, a lowest ask price, a traded price and a traded volume in respect of each trade in such traded security;
(A) determining, for each trade, if the bid price is less than the ask price, and if so:
(i) determining if the traded price is greater than the bid price and if the traded price is less than the ask price, and if so:
(a) calculating a first data construct (SPREAD) with respect to such trade as being said difference between said ask price and said bid price;
(b) calculating a second data construct (UPV) with respect to such trade as the traded price less the bid price divided by the ask price less the bid price multiplied by the traded volume;
(c) calculating a third data construct (DNV) with respect to such trade as being the traded volume less the UPV;
(d) calculating a fourth data construct (NSP) with respect to such trade by multiplying DNV×SPREAD;
(e) calculating a fifth data construct (NBP) with respect to such trade by multiplying UPV×SPREAD;
(ii) determining if the traded price is equal to the ask price and if the traded price is greater than the bid price, and if so:
(a) calculating a first data construct (SPREAD) with respect to such trade as being the difference between said ask price and said bid price;
(b) calculating a second data construct (UPV) with respect to such trade as the traded price less the bid price divided by the ask price less that the bid price multiplied by the traded volume;
(c) calculating a third data construct (DNV) with respect to such trade as being the traded volume less the UPV;
(d) calculating a fourth data construct (NSP) with respect to such trade by multiplying DNV×SPREAD;
(e) calculating a fifth data construct (NBP) with respect to such trade by multiplying UPV×SPREAD;
(iii) determining if the traded price is equal to the bid price and if the traded price is less than the ask price, and if so:
(a) calculating a first data construct (SPREAD) with respect to such trade as being said difference between said ask price and said bid price;
(b) calculating a second data construct (UPV) with respect to such trade as the traded price less the bid price divided by the ask price less the bid price multiplied by the traded volume;
(c) calculating a third data construct (DNV) with respect to such trade as being the traded volume less the UPV;
(d) calculating a fourth data construct (NSP) with respect to such trade by multiplying DNV×SPREAD;
(e) calculating a fifth data construct (NBP) with respect to such trade by multiplying UPV×SPREAD;
(iv) determining if the traded price is less than the bid price and if the traded price is less than the ask price, and if so:
(a) calculating a first data construct (SPREAD) with respect to such trade as being said difference between said ask price and said traded price;
(b) setting a second data construct (UPV) with respect to such trade as being equal to zero;
(c) calculating a third data construct (DNV) with respect to such trade as being the traded volume less the UPV;
(d) calculating a fourth data construct (NSP) with respect to such trade by multiplying DNV×SPREAD;
(e) calculating a fifth data construct (NBP) with respect to such trade by multiplying UPV×SPREAD;
(v) determining if the traded price is greater than the ask price and if the traded price is greater than the bid price, and if so:
(a) calculating a first data construct (SPREAD) with respect to such trade as being said difference between said traded price and the bid price;
(b) calculating a second data construct (UPV) with respect to such trade as being equal to the traded volume;
(c) calculating a third data construct (DNV) with respect to such trade as being the traded volume less the UPV;
(d) calculating a fourth data construct (NSP) with respect to such trade by multiplying DNV×SPREAD;
(e) calculating a fifth data construct (NBP) with respect to such trade by multiplying UPV×SPREAD;
(B) determining, for each trade, if the ask price is equal to the bid price (ask=bid), and if so:
(i) determining if the traded price is greater than the ask price or bid price, and if so:
(a) calculating a first data construct (SPREAD) for such trade as being said difference between said last traded price and the bid price;
(b) calculating a second data construct (UPV) for such trade as being equal to the traded volume;
(c) calculating a third data construct (DNV) for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD;
(ii) determining if the traded price is equal to the ask price or the bid price, and if so:
(a) setting a first data construct (SPREAD) for such trade as being equal to zero;
(b) calculating a second data construct (UPV) for such trade as being equal to one-half of the traded volume;
(c) calculating a third data construct (DNV) for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD;
(iii) determining if the traded price is less than the ask price or the bid price, and if so:
(a) calculating a first data construct (SPREAD) for such trade as being the difference between said bid price and the last traded price;
(b) setting a second data construct (UPV) for such trade as being equal to zero;
(c) calculating a third data construct (DNV) for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD;
(C) determining, for each trade, if the bid price is greater than the ask price, and if so:
(i) determining if the traded price is less than the bid price and if the traded price is greater than the ask price, and if so:
(a) calculating a first data construct (SPREAD) for such trade as being said difference between said bid price and the traded price;
(b) calculating a second data construct (UPV) for such trade as being equal to one-half of the traded volume;
(c) calculating a third data construct (DNV) for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD;
(ii) determining if the traded price is equal to the bid price and if the traded price is greater than the ask price, and if so:
(a) calculating a first data construct (SPREAD) for such trade as said bid price less said traded price;
(b) calculating a second data construct (UPV) for such trade as being equal to one-half of the traded volume;
(c) calculating a third data construct (DNV) for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD;
(iii) determining if the traded price is greater than the bid price and if the traded price is greater than the ask price, and if so:
(a) Calculating a first data construct (SPREAD) for such trade as being the difference between said traded price and the bid price;
(b) calculating a second data construct (UPV) for such trade as being equal to the traded volume;
(c) calculating a third data construct (DNV) for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD;
(iv) determining if the traded price is equal to the ask price, and if the traded price is less than the bid price, and if so:
(a) calculating a first data construct (SPREAD) for such trade as being the difference between said bid price and the traded price;
(b) calculating a second data construct (UPV) for such trade as being equal to one-half of the traded volume;
(c) calculating a third data construct (DNV) for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD; and
(v) determining if the traded price is less than the ask price and if the traded price is less than the bid price, and if so:
(a) calculating a first data construct (SPREAD) for such trade as being the difference between said bid price and the traded price;
(b) setting a second data construct (UPV) for such trade as being equal to zero
(c) calculating a third data construct (DNV) for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD.

8. The method of claim 7 further comprising the steps of creating further data constructs RBP and RSP in respect of a traded security which may be used to assist in determining whether it would be advantageous to buy or sell said security, further comprising the steps of:
(D) summing each of the calculated DNV, UPV, NSP, and NBP as well as the traded volume for each trade over a defined time interval to create respectively the following data constructs SUMDNV, SUMUPV, SUMNSP, SUMNBP and SUMVOL for said defined interval; and
(E) calculating a data construct (RSP) for said time interval, as being:
[SUMNSP/(SUMNSP+SUMNBP)]×SUMVOL
and
(F) calculating a data construct (RBP) for said time interval, as being:
[SUMNBP/(SUMNSP+SUMNBP)]×SUMVOL

9. One or more data constructs NBP, NSP, UPV, or DNV for a traded security, wherein said one or more data constructs are determined by the method of one or more of claims 1, 3, or 5.

10. One or more data constructs RBP and RSP for a traded security for a plurality of time intervals, wherein said one or more data constructs are determined for the plurality of time intervals by the method of one or more of claims 2, 4, or 6.

11. One or more data constructs NBP, NSP, UPV, or DNV for a traded security, wherein said one or more data constructs are determined by the method of claim 7.

12. One or more data constructs RBP or RSP for a traded security for a plurality of time intervals, wherein said one or more data constructs are determined for the plurality of time intervals by the method of claim 8.

13. A method of operating a trading system for a traded security using data constructs RSP and RBP as calculated in accordance with the method of claim 8, wherein said security is purchased when a criteria for purchasing said security includes a determination that a calculated value of RBP for said security for a particular time interval has transitioned from a value less than RSP during previous time intervals to a value greater than said RSP.

14. A method of operating a trading system for a traded security using data constructs RSP and RBP as calculated in accordance with the method of claim 8 over a plurality of time intervals, wherein said security is sold when a criteria for purchasing said security includes a determination that a calculated value of RSP for said security for a particular time interval has transitioned from a value greater than RBP during previous time intervals to a value less than said RBP.

15. A method of operating a trading system for a traded security in accordance with the method of claim 13, further comprising the step of, prior to purchasing said security, conducting at least one backtesting step comprising:
(i) retrieving previously-calculated data constructs RBP and RSP for a plurality of prior time intervals prior to a most recent time interval, hereinafter RBP(Prior) and RSP(Prior);
(ii) determining an instance within said plurality of prior time intervals prior to said most recent time interval where RSP(Prior) transitioned from less than RBP(Prior) to greater than RBP(Prior);
(iii) determining if a traded price of said security dropped immediately subsequent to said instance when RSP(Prior) transitioned from a value less than RBP(Prior) to a value greater than RBP(Prior); and
(iv) only initiating a selling of said security if said traded price of said security dropped immediately after said RSP(Prior) transitioned from less than RBP(Prior) to greater than RBP(Prior) in step (iii).

16. A method of operating a trading system for a traded security in accordance with the method of claim 14, further comprising the step of, prior to selling said security, conducting at least one backtesting step comprising:
(i) retrieving previously-calculated data constructs RBP and RSP for a plurality of prior time intervals prior to a most recent time interval, hereinafter RBP(Prior) and RSP(Prior) respectively;
(ii) determining an instance within said plurality of prior time intervals prior to said most recent time interval where RBP(Prior) transitioned from less than RSP(Prior) to greater than RSP(Prior);
(iii) determining if a traded price of said security rose immediately subsequent to said instance when RBP(Prior) transitioned from a value less than RSP(Prior) to greater than RSP(Prior); and
(iv) only initiating purchasing of said security if said traded price of said security rose immediately after said RSP(Prior)) transitioned from less than RBP(Prior) to greater than RBP(Prior) in step (iii).

17. Use of an existing method for determining whether to buy or sell a security, which method uses data constructs RSP and RBP determined in accordance with the method of claim 2 or 8.

18. Use of relative strength index method for determining whether to buy or sell a security which uses data constructs RSP and RBP determined in accordance with the method of claim 2 or 8.

19. Use of stochastic methods for determining whether to buy or sell a security, which stochastic method uses data constructs RSP and RBP determined in accordance with the method of claim 2 or 8.

20. Use of a moving average convergence divergence (MACD) method of determining whether to buy or sell a security, which MACD method uses data constructs RSP and RBP determined in accordance with the method of claim 2 or 8.

21. Use of an existing method of stock performance prediction for determining whether to buy or sell a security, wherein said method is selected from the group of stock performance prediction methods comprising stochastic % K % D, relative strength index, and moving average convergence divergence (MACD), which method uses data constructs RSP and RBP determined in accordance with the method of claim 2 or 8.

22. A data transforming and supply system for transforming trading data in relation to one or more securities into new data constructs for said security which may be purchased for a fee, comprising:
means for receiving raw data in respect of a plurality of consecutive trades in a traded security, such raw data including, or calculating from such raw data, a highest bid price, a lowest ask price, a traded price and a traded volume in respect of each trade in such traded security;
(A) means for determining, for each trade, if the bid prices is less than the ask price, and if so:
(i) determining if the traded price is greater than the bid price and if the traded price is less than the ask price, and if so:
(a) calculating a first data construct (SPREAD) with respect to such trade as being said difference between said ask price and said bid price;
(b) calculating a second data construct (UPV) with respect to such trade as the traded price less the bid price divided by the ask price less the bid price multiplied by the traded volume;
(c) calculating a third data construct (DNV) with respect to such trade as being the traded volume less the UPV;
(d) calculating a fourth data construct (NSP) with respect to such trade by multiplying DNV×SPREAD;
(e) calculating a fifth data construct (NBP) with respect to such trade by multiplying UPV×SPREAD;
(ii) means for determining if the traded price is equal to the ask price and if the traded price is greater than the bid price, and if so:
(a) calculating a first data construct (SPREAD) with respect to such trade as being the difference between said ask price and said bid price;
(b) calculating a second data construct (UPV) with respect to such trade as the traded price less the bid price divided by the ask price less that the bid price multiplied by the traded volume;
(c) calculating a third data construct (DNV) with respect to such trade as being the traded volume less the UPV;
(d) calculating a fourth data construct (NSP) with respect to such trade by multiplying DNV×SPREAD;
(e) calculating a fifth data construct (NBP) with respect to such trade by multiplying UPV×SPREAD;
(iii) means for determining if the traded price is equal to the bid price and if the traded price is less than the ask price, and if so:
(a) calculating a first data construct (SPREAD) with respect to such trade as being said difference between said ask price and said bid price;
(b) calculating a second data construct (UPV) with respect to such trade as the traded price less the bid price divided by the ask price less the bid price multiplied by the traded volume;
(c) calculating a third data construct (DNV) with respect to such trade as being the traded volume less the UPV;
(d) calculating a fourth data construct (NSP) with respect to such trade by multiplying DNV×SPREAD;
(e) calculating a fifth data construct (NBP) with respect to such trade by multiplying UPV×SPREAD;
(iv) means for determining if the traded price is less than the bid price and if the traded price is less than the ask price, and if so:
(a) calculating a first data construct (SPREAD) with respect to such trade as being said difference between said ask price and said traded price;
(b) setting a second data construct (UPV) with respect to such trade as being equal to zero;
(c) calculating a third data construct (DNV) with respect to such trade as being the traded volume less the UPV;
(d) calculating a fourth data construct (NSP) with respect to such trade by multiplying DNV×SPREAD;
(e) calculating a fifth data construct (NBP) with respect to such trade by multiplying UPV×SPREAD;
(v) means for determining if the traded price is greater than the ask price and if the traded price is greater than the bid price, and if so:
(a) calculating a first data construct (SPREAD) with respect to such trade as being said difference between said traded price and the bid price;
(b) calculating a second data construct (UPV) with respect to such trade as being equal to the traded volume;
(c) calculating a third data construct (DNV) with respect to such trade as being the traded volume less the UPV;
(d) calculating a fourth data construct (NSP) with respect to such trade by multiplying DNV×SPREAD;
(e) calculating a fifth data construct (NBP) with respect to such trade by multiplying UPV×SPREAD;
(B) means for determining, for each trade, if the bid price is equal to the ask price, and if so:
(i) determining if the traded price is greater than the ask price or bid price, and if so:
(a) calculating a first data construct (SPREAD) for such trade as being said difference between said last traded price and the bid price;
(b) calculating a second data construct (UPV) for such trade as being equal to the traded volume;
(c) calculating a third data construct (DNV) for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD;
(ii) means for determining if the traded price is equal to the ask price or the bid price, and if so:
(a) setting a first data construct (SPREAD) for such trade as being equal to zero;
(b) calculating a second data construct (UPV) for such trade as being equal to one-half of the traded volume;
(c) calculating a third data construct (DNV) for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD;
(iii) means for determining if the traded price is less than the ask price or the bid price, and if so:
(a) calculating a first data construct (SPREAD) for such trade as being the difference between said bid price and the last traded price;
(b) setting a second data construct (UPV) for such trade as being equal to zero;
(c) calculating a third data construct (DNV) for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD;
(C) means for determining, for each trade, if the bid price is greater than the ask price, and if so:
(i) determining if the traded price is less than the bid price and if the traded price is greater than the ask price, and if so:
(a) calculating a first data construct (SPREAD) for such trade as being said difference between said bid price and the traded price;
(b) calculating a second data construct (UPV) for such trade as being equal to one-half of the traded volume;
(c) calculating a third data construct (DNV) for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD;
(ii) determining if the traded price is equal to the bid price and if the traded price is greater than the ask price, and if so:
(a) calculating a first data construct (SPREAD) for such trade as said bid price less said traded price;
(b) calculating a second data construct (UPV) for such trade as being equal to one-half of the traded volume;
(c) calculating a third data construct (DNV) for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD;
(iii) determining if the traded price is greater than the bid price and if the traded price is greater than the ask price, and if so:
(a) calculating a first data construct (SPREAD) for such trade as being the difference between said traded price and the ask price;
(b) calculating a second data construct (UPV) for such trade as being equal to the traded volume;
(c) calculating a third data construct (DNV) for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD;
(iv) determining if the traded price is equal to the ask price, and if the traded price is less than the bid price, and if so:
(a) calculating a first data construct (SPREAD) for such trade as being the difference between said bid price and the traded price;
(b) calculating a second data construct (UPV) for such trade as being equal to one-half of the traded volume;
(c) calculating a third data construct (DNV) for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD; and
(v) determining if the traded price is less than the ask price and if the traded price is less than the bid price, and if so:
(a) calculating a first data construct (SPREAD) for such trade as being the difference between said bid price and the traded price;
(b) setting a second data construct (UPV) for such trade as being equal to zero;
(c) calculating a third data construct (DNV) for such trade as being the traded volume less the UPV;
(d) calculating a fourth data construct (NSP) for such trade by multiplying DNV×SPREAD;
(e) calculating a fifth data construct (NBP) for such trade by multiplying UPV×SPREAD; and
(D) means for supplying such data constructs DNV, UPV, NSP, and NBP to members of the public for a fee.

23. The data transforming and supply system as claimed in claim 22, further comprising the steps of:
(D) means for summing each of the calculated DNV, UPV, NSP, and NBP as well as the traded volume for each trade over said defined time interval to create respectively the following data constructs SUMDNV, SUMUPV, SUMNSP, SUMNBP and SUMVOL for said defined interval;
(E) means for calculating a data construct (RSP) for said time interval, as being:
[SUMNSP/(SUMNSP+SUMNBP)]×SUMVOL
(F) means for calculating a data construct (RBP) for said time interval, as being:
[SUMNBP/(SUMNSP+SUMNBP)]×SUMVOL
and
(G) means for supplying such data constructs RBP and RSP to members of the public for a fee.

24. A method of transforming trading data for a traded security so as to create new financial data constructs NBP, NSP, UPV, and NPV in respect of trades in such traded security, comprising:
utilizing data in respect of a plurality of consecutive trades in a traded security over a defined time interval, such data for each trade including a bid price, an ask price, a last traded price and a traded volume over said defined time interval;
determining, for each time interval, if the highest bid price is less than the lowest ask price, and if so:
(i) determining if the last traded price is greater than the highest bid price and the last traded price is less than the lowest ask price, and if so:
(a) calculating a first data construct (SPREAD) with respect to such trade as being said difference between said lowest ask price and said highest bid price;
(b) calculating a second data construct (UPV) with respect to such trade as the traded price less the bid price divided by the ask price less the bid price multiplied by the traded volume;
(c) calculating a third data construct (DNV) with respect to such trade as being the traded volume less the UPV;
(d) calculating a fourth data construct (NSP) with respect to such trade by multiplying DNV×SPREAD;
(e) calculating a fifth data construct (NBP) with respect to such trade by multiplying UPV×SPREAD;
(ii) determining if the last traded price is equal to the lowest ask price and the last traded price is greater than the highest bid price, and if so:
(a) calculating a first data construct (SPREAD) with respect to such trade as being the difference between said lowest ask price and said highest bid price;
(b) calculating a second data construct (UPV) with respect to such trade as the traded price less the bid price divided by the ask price less that the bid price multiplied by the traded volume;
(c) calculating a third data construct (DNV) with respect to such trade as being the traded volume less the UPV;
(d) calculating a fourth data construct (NSP) with respect to such trade by multiplying DNV×SPREAD;
(e) calculating a fifth data construct (NBP) with respect to such trade by multiplying UPV×SPREAD;
(iii) determining if the last traded price is equal to the highest bid price and if the last traded price is less than the lowest ask price, and if so:
(a) calculating a first data construct (SPREAD) with respect to such trade as being said difference between said lowest ask price and said highest bid price;
(b) calculating a second data construct (UPV) with respect to such trade as the traded price less the bid price divided by the ask price less the bid price multiplied by the traded volume;
(c) calculating a third data construct (DNV) with respect to such trade as being the traded volume less the UPV;
(d) calculating a fourth data construct (NSP) with respect to such trade by multiplying DNV×SPREAD;
(e) calculating a fifth data construct (NBP) with respect to such trade by multiplying UPV×SPREAD;
(iv) determining if the last traded price is less than the highest bid price and if the traded price is less than the lowest ask price, and if so:
(a) calculating a first data construct (SPREAD) with respect to such trade as being said difference between said lowest ask price and said traded price;
(b) setting a second data construct (UPV) with respect to such trade as being equal to zero;
(c) calculating a third data construct (DNV) with respect to such trade as being the traded volume less the UPV;
(d) calculating a fourth data construct (NSP) with respect to such trade by multiplying DNV×SPREAD;
(e) calculating a fifth data construct (NBP) with respect to such trade by multiplying UPV×SPREAD;
(v) determining if the last traded price is greater than the lowest ask price and if the traded price is greater than highest bid price, and if so:
(a) calculating a first data construct (SPREAD) with respect to such trade as being said difference between said traded price and the highest bid price;
(b) calculating a second data construct (UPV) with respect to such trade as being equal to the traded volume;
(c) calculating a third data construct (DNV) with respect to such trade as being the traded volume less the UPV;
(d) calculating a fourth data construct (NSP) with respect to such trade by multiplying DNV×SPREAD;
(e) calculating a fifth data construct (NBP) with respect to such trade by multiplying UPV×SPREAD.

25. The method of claim 24, further comprising the steps of creating further data constructs RBP and RSP for each time interval, comprising the steps of:
summing each of the calculated DNV, UPV, NSP, and NBP as well as the traded volume over a defined time interval to create respectively the following data constructs SUMDNV, SUMUPV, SUMNSP, SUMNBP and SUMVOL for said defined time interval; and
calculating said data construct (RSP) for said time interval, as being:
[SUMNSP/(SUMNSP+SUMNBP)]×SUMVOL
and
calculating said data construct (RBP) for said time interval, as being:
[SUMNBP/(SUMNSP+SUMNBP)]×SUMVOL
